(19) United States
(12) Patent Application Publication
(10) Pub. No.: US 2017/0289185 A1
(43) Pub. Date: Oct. 5, 2017

(54) DEVICE ASSISTED TRAFFIC ANOMALY DETECTION

(71) Applicant: QUALCOMM Incorporated, San Diego, CA (US)

(72) Inventor: Giridhar MANDYAM, San Diego, CA (US)

(21) Appl. No.: 15/368,340

(22) Filed: Dec. 2, 2016

Related U.S. Application Data
(60) Provisional application No. 62/316,164, filed on Mar. 31, 2016.
(60) Provisional application No. 62/367,275, filed on Jul. 27, 2016.

(51) Int. Cl. H04L 29/06

(52) U.S. Cl. CPC H04L 63/1425; H04L 63/1416; H04L 67/42

(57) ABSTRACT

Techniques for traffic anomaly detection are provided. A method according to these techniques includes producing, at a client device, a handshake message for initiating a handshake with a relying party, analyzing, at the client device, the handshake message to determine whether the handshake message is anomalous, and associating, at the client device, an attestation with the handshake message, the attestation indicating whether the client device determined that the handshake message is anomalous.

### CROSS REFERENCE TO RELATED APPLICATION

This application claims priority to U.S. Provisional Patent Application Ser. No. 62/316,164, entitled “TRANSPORT LAYER SECURITY TOKEN BINDING AND TRUSTED SIGNING,” filed on Mar. 31, 2016, which is assigned to the assignee hereof and incorporated by reference. This application also claims priority to U.S. Provisional Patent Application Ser. No. 62/367,275, entitled “DEVICE ASSISTED COMMUNICATION TRAFFIC ANOMALY DETECTION,” filed on Jul. 27, 2016, which is also assigned to the assignee hereof and incorporated by reference.

### BACKGROUND

Computer-based communications through computer networks have increased exponentially to where the overwhelming majority of persons engage in multiple computer-based communications daily. The incredible volume of such communications has, however, led to attacks on these communications, often for malicious purposes, and often for financial gain, e.g., theft. Attacks on computer-based communications may be identified by detecting anomalies in communication traffic. For example, network-based apparatus may be used to analyze traffic for anomalies, i.e., characteristics of the traffic that are out of the norm or not expected.

### SUMMARY

An example traffic anomaly detection method according to the disclosure includes producing, at a client device, a handshake message for initiating a handshake with a relying party, analyzing, at the client device, the handshake message to determine whether the handshake message is anomalous, and associating, at the client device, an attestation with the handshake message, the attestation indicating whether the client device determined that the handshake message is anomalous.

Implementations of such a traffic anomaly detection method may include one or more of the following features. Analyzing the handshake message includes analyzing a 5-tuple of source Internet Protocol address, source port, destination Internet Protocol address, destination port, and traffic type to determine whether the 5-tuple is within expectations. Analyzing the handshake message includes analyzing a cipher suite of the handshake message. Analyzing the handshake message includes analyzing a certificate of the handshake message. Analyzing the handshake message includes analyzing application characteristics. Analyzing the handshake message includes analyzing a combination of source application, destination address, and traffic type.

An example device according to the disclosure includes a transceiver, a memory, and a processor communicatively coupled to the transceiver and to the memory. The processor is configured to: produce a handshake message for initiating a handshake with a relying party, analyze the handshake message to determine whether the handshake message is anomalous, and associate an attestation with the handshake message, the attestation indicating whether the processor determined that the handshake message is anomalous.

Implementations of such a device may include one or more of the following features. The processor is configured to analyze a 5-tuple of source Internet Protocol address, source port, destination Internet Protocol address, destination port, and traffic type to determine whether the 5-tuple is within expectations. The processor is configured to analyze a cipher suite of the handshake message. To analyze the handshake message the processor is configured to analyze a certificate of the handshake message. To analyze the handshake message the processor is configured to analyze application characteristics. To analyze the handshake message the processor is configured to analyze a combination of source application, destination address, and traffic type. To produce the handshake message the processor is configured to implement a web browser and wherein the handshake message is a transport layer security message.

An example traffic monitor according to the disclosure includes a transceiver, a memory, and a processor communicatively coupled to the transceiver and to the memory. The processor is configured to: receive a handshake message from a client device via the transceiver; determine whether an attestation from the client device is associated with the handshake message; respond to the attestation being associated with the handshake message by attempting to verify an authenticity of the attestation; and respond to no attestation being associated with the handshake message by analyzing the handshake message for an anomaly or terminating a handshake.

Implementations of such a traffic monitor may include one or more of the following features. The processor is configured to attempt to verify the authenticity of the attestation responsive to the attestation being associated with the handshake message, and the processor is further configured to analyze the handshake message for an anomaly or to terminate the handshake responsive to failing to verify the authenticity of the attestation. The processor is further configured to send the handshake message to a relying party responsive to verifying that the handshake message is not anomalous. The processor is further configured to respond to verifying that the attestation is authentic and indicates that the handshake message is not anomalous by sending the handshake message to a relying party via the transceiver.

### BRIEF DESCRIPTION OF THE DRAWINGS

FIG. 1 is a schematic diagram of an example operating environment that includes a mobile wireless device in communication with one or more wireless nodes, in accordance with certain example implementations.

FIG. 2 is a schematic diagram of an example wireless device (e.g., a mobile wireless device), in accordance with certain example implementations.

FIG. 3 is a schematic diagram of an example server, in accordance with certain example implementations.

FIG. 4 is a schematic diagram of an example computing system, in accordance with certain example implementations.

FIG. 5 is a flow diagram of an example process in which a client device can obtain an access token from an access server, in accordance with certain example embodiments.

FIG. 6 is a flow diagram of an example process for generating an access token, in accordance with certain example embodiments.

FIG. 7A is a flow diagram of an example process for managing data communications, in accordance with certain example embodiments.

FIG. 7B is a flow diagram of an example process for establishing a secure communication session, in accordance with certain example embodiments.

FIG. 8A is a flow diagram of an example process for establishing a secure communication session, in accordance with certain example embodiments.

FIG. 8B is a flow diagram of an example process for establishing a secure communication session, in accordance with certain example embodiments.

FIG. 9 is a signal flow diagram illustrating example interactions between a client device and a relying party to conduct an secure communication session in accordance with certain example implementations.

FIG. 10 is a block diagram of components of an example traffic monitor, such as that shown in FIG. 1.

FIG. 11 is a flow diagram of a method of traffic anomaly detection.

FIG. 12 is a diagram of a method of handshaking between a browser and a relying party.

FIGS. 13, 14, and 15 are flow diagrams of methods of traffic anomaly detection.

Like reference symbols in the various drawings indicate like elements, in accordance with certain example implementations.

### DETAILED DESCRIPTION

Described herein are methods, systems, devices, computer readable media, and other implementations, for implementing token binding techniques that can be used to establish a secure communication session between a client device and a server over a network, such as the collection of networks collectively referred to as the Internet. An access token can be provided by a client device to a server to indicate to the server that the user of the client device is authorized to access an application or some content provided by the server. The access token may be obtained from an authorization server by the client device, and may be obtained by presenting authorization credentials, such as a username and password or other information that may be used to identify a user of the client device or the client device itself, to the authentication server (referred to herein as an access server). The authentication server may then issue an access token to the client device that the client device can present to a relying party (for example, a content server) to indicate that the user is entitled to access applications, content, and/or services provided by the relying party. The access token may be valid for applications, content, and/or services provided by the relying party or provided by more than one relying party. For example, the access token may provide access to social media content, email content, an online shopping account, and/or other types of applications, content, and/or services.

Possession of the access token alone, however, may be insufficient to ensure that the user is actually authorized to possess the access token. The access token may have been stored in a rich execution environment of the client device, and the token may have been manipulated or even stolen while stored in such an environment. A rich execution environment can be used to execute application content on the client device and the content associated with the rich execution environment may be subject to unauthorized manipulation by malicious third parties through software and/or hardware exploits. An access token stored in the rich execution environment may be stolen through such a software or hardware exploit and may be used by the malicious party to obtain unauthorized access to the applications, content, and/or services accessible using the access token. To prevent theft of the access token, the access token may also be stored in a trusted execution environment or trusted component of the client device. The trusted execution environment or trusted component can provide an execution environment that is isolated from the rich execution environment and can provide for protected execution of authenticated code, confidentiality, and data integrity. The trusted execution environment or trusted component can be used to store sensitive information, such as encryption keys and the access tokens, to reduce the likelihood that this sensitive information may be stolen or modified by a malicious third party.

According to the techniques disclosed herein, the client device can be configured to provide attestation information with the access token. The attestation information can be used to provide information that a relying party can use to determine whether to provide access to the client device. The attestation information can provide information including whether the client device stores the encryption keys and access tokens in a trusted execution environment or trusted component or in the rich execution environment. The attestation information can also indicate which encryption algorithms the client device supports. The attestation information can be used by the relying party to make a determination whether to provide access to a requested application, requested content, or a requested service. The attestation information can also include other information that the relying party can use to make such a determination. Furthermore, the relying party can utilize policy information that defines the specific level of security that is required for the client device to be able to access the particular application, content, or service. Some applications, content, or services may require that the client device implement stronger security safeguards for maintaining the integrity and authenticity of the access token, encryption keys utilized by the client device, etc. For example, a server-side policy may require that the client device store the access tokens and encryption keys in a trusted execution environment or trusted component in order to access a banking or financial application, content, or service, but may implement a server-side policy that allows access to social media related applications, content, or services by client devices that store access tokens in a rich execution environment.

The techniques disclosed herein can be used to increase security to the Transport Layer Security protocol and/or other such secure communication protocols. A client device can obtain an access token that can be used in conducting a secure communication session with a relying party. The access token can comprise information that can be used to securely bind together one or more subsessions of the secure communications session. The information included in the access token can be a public key of a private key-public key set of encryption keys. The private key is kept secret by the client device and can be used to encrypt a nonce value provided by the relying party. The relying party can decrypt the encrypted nonce value using the public key associated with the client device to establish that the client device was in possession of the private key. These techniques can inhibit or even prevent the access token from being exported by a malicious party and exploited to obtain access to applications, content, or services by an unauthorized party from another client device, because the other client device would not possess the required private key. The techniques disclosed herein can provide an additional layer of security by providing attestation information to the relying party in addition to the access token. The attestation information can indicate how the client device manages the storage and security of encryption keys and the access tokens, so that the relying party does not have to operate on the assumption that the encryption keys and/or the access token may have been stored in an unsecure manner on the client device.

Further, techniques are discussed for analyzing a handshake message for an anomaly. For example, a client device may analyze a handshake message (such as a TLS handshake message) for one or more anomalies. The client device may associate an attestation with the handshake message indicating that the handshake message is anomalous or not anomalous and send the handshake message and the attestation to a traffic monitor. Alternatively, the client device may terminate a handshake in response to the client device determining that the handshake message is anomalous. The traffic monitor may analyze a communication from the client device to determine whether a handshake message has an associated attestation from the client device, and to attempt to verify the authenticity of any such attestation. The traffic monitor may respond to the handshake message not having an associated attestation, or having an attestation that the traffic monitor does not verify as being authentic, or having an attestation that the traffic monitor verifies as authentic and that indicates that the handshake message is anomalous, by analyzing the handshake message for one or more anomalies or terminating the handshake. The traffic monitor may respond to the handshake message having an attestation that the traffic monitor verifies as authentic and that indicates that the handshake message is not anomalous by sending the handshake message to a relying party.

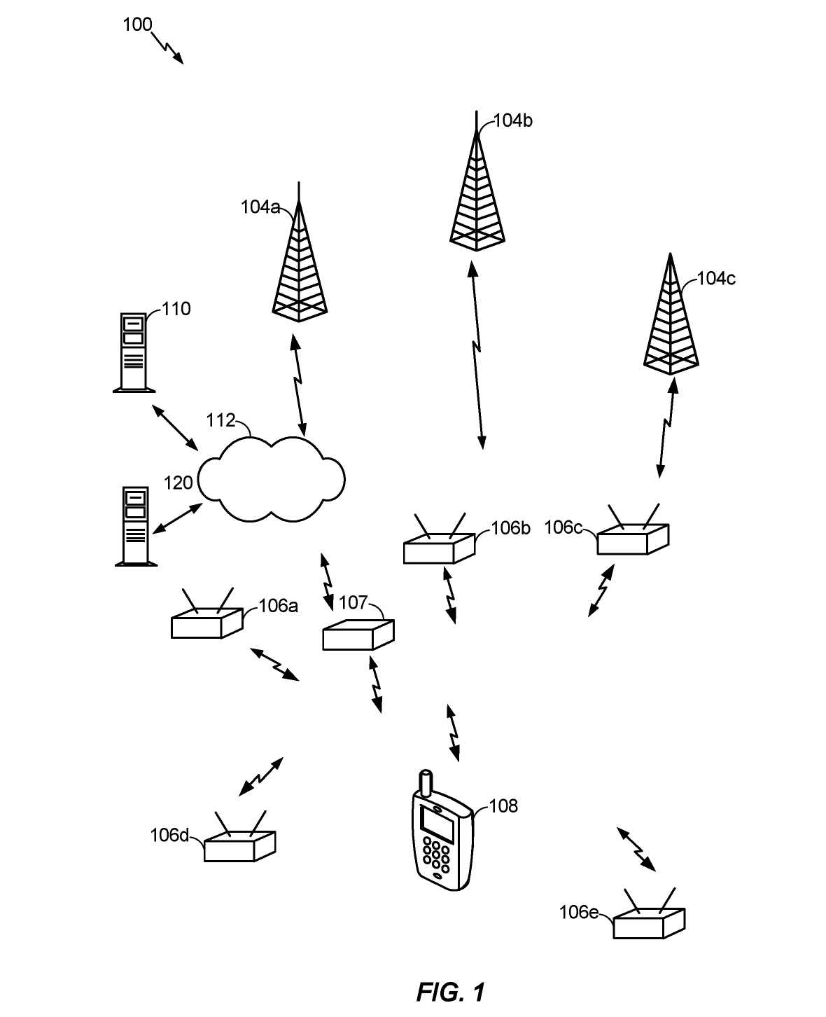

With reference to FIG. 1, shown is a schematic diagram of an example operating environment 100 that includes a client device 108 (also referred to as a mobile wireless device, a mobile station, and a wireless device) in communication with one or more wireless nodes. The client device 108 can serve as the client device in the various techniques disclosed herein. In some implementations, the client device 108 may be implemented in a computing device that is stationary or may be moveable, but is typically not moved, such as a desktop computer system, smart television, or other type of network-enabled computing device from which a user may access applications, content, and/or services provided by a relying party 120 or from another network entity or entities from which the relying party 120 has authorized the client device 108 to access the applications, content, and/or services. The client device 108 can also be configured to obtain an access token from an access server 110, and the access token can include information which can be used to bind one or more communication sub-sessions to a secure communication session between the client device and the relying party 120. The relying party 120 can be configured to provide or authorize access to content related to online banking and/or investments, social media, payment systems, enterprise data systems, online retail, and/or other content which can include sensitive data for which access to view and/or modify the content or conduct transactions is desired.

The client device 108 is configured, in some embodiments, to obtain location information for one or more of the wireless nodes (e.g., access points 104a-c and 106a-e depicted in FIG. 1, or another client device) with which the client device 108 communicates, to receive and measure signals from the one or more wireless nodes (e.g., to determine/derive signal strength values for the received signals), to process the received and measured signals based, at least in part, on the obtained location information, to determine the range of the client device 108 to one or more of the wireless nodes, and/or to perform other operations utilizing the ranging information such as determining the location of the client device 108.

The client device 108 may be configured, in some embodiments, to operate and interact with multiple types of other communication systems/devices, including local area network devices (or nodes), such as WLAN for indoor communication, femtocells, Bluetooth® wireless technology-based transceivers, and other types of indoor communication network nodes, wide area wireless network nodes, satellite communication systems, etc., and as such the client device 108 may include one or more interfaces to communicate with the various types of communications systems. As used herein, communication systems/devices/nodes with which the client device 108 may communicate are also referred to as access points (APs) or base stations.

As noted, the operating environment 100 may contain one or more different types of wireless communication systems or nodes. Such nodes, also referred to as wireless access points (or WAPs) may include LAN and/or WAN wireless transceivers, including, for example, WiFi base stations, femtocell transceivers, Bluetooth® wireless technology transceivers, cellular transceivers, WiMax transceivers, etc. Thus, for example, and with continued reference to FIG. 1, the operating environment 100 may include the Local Area Network Wireless Access Points (LAN-WAPs) 106a-e that may be used for wireless voice and/or data communication with the client device 108. The LAN-WAPs 106a-e may also be utilized, in some embodiments, as independent sources of position data, e.g., through fingerprinting-based procedures, through implementation of multilateration-based procedures based, for example, on timing-based techniques (e.g., RTT-based measurements), signal strength measurements (e.g., RSSI measurements), etc. The LAN-WAPs 106a-e can be part of a Wireless Local Area Network (WLAN), which may operate in buildings and perform communications over smaller geographic regions than a WWAN. Additionally in some embodiments, the LAN-WAPs 106a-e could also include picocells or femtocells. In some embodiments, the LAN-WAPs 106a-e may be part of, for example, WiFi networks (802.11x), cellular piconets and/or femtocells, Bluetooth® wireless technology networks, etc. Although five (5) LAN-WAP access points are depicted in FIG. 1, any number of such LAN-WAPs may be used, and, in some embodiments, the operating environment 100 may include no LAN-WAPs at all, or may include a single LAN-WAP.

As further illustrated, the operating environment 100 may also include a plurality of one or more types of Wide Area Network Wireless Access Points (WAN-WAPs) 104a-c, which may be used for wireless voice and/or data communication, and may also serve as sources of independent information through which the client device 108 may determine its position/location. The WAN-WAPs 104a-c may be part of wide area wireless network (WWAN), which may include cellular base stations and/or other wide area wireless systems, such as, for example, WiMAX (e.g., 802.16) systems. A WWAN may include other network components which are not shown in FIG. 1. Typically, each of the WAN-WAPs 104a-104c within the WWAN may operate from a fixed position or may be moveable, and may provide network coverage over a large metropolitan and/or regional area. Although three (3) WAN-WAPs are depicted in FIG. 1, any number of such WAN-WAPs may be used. In some embodiments, the operating environment 100 may include no WAN-WAPs at all, or may include a single WAN-WAP.

Communication to and from the client device 108 (to exchange data, enable location determination operations with respect to the position(s) of the client device 108, etc.) may be implemented, in some embodiments, using various wireless communication networks and/or technologies such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

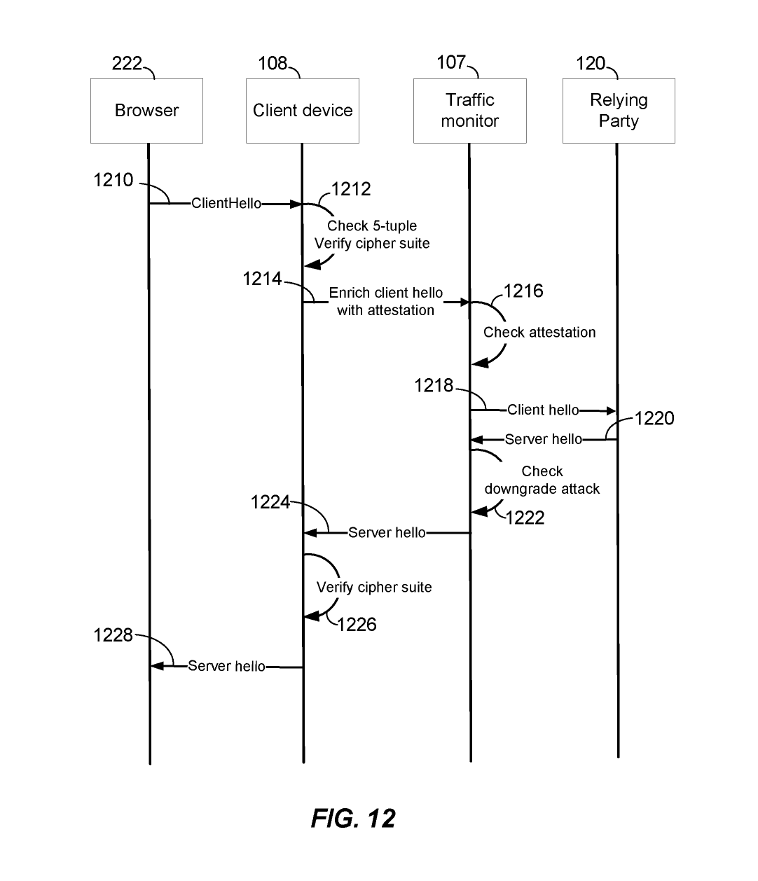

Communication between the client device 108 and a network 112 may pass through a traffic monitor 107. The traffic monitor 107 may be considered to be a network-based monitor although the traffic monitor 107 may physically reside near the client device 108, e.g., in a house or business associated with the client device 108. With reference now to FIG. 10, a schematic diagram illustrating various components of an example traffic monitor 1000, which may be similar to or the same as the traffic monitor 107 depicted in FIG. 1, is shown. For the sake of simplicity, the various features/components/functions illustrated in the schematic boxes of FIG. 10 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 10 may be further subdivided, or two or more of the features or functions illustrated in FIG. 10 may be combined. Additionally, one or more of the features or functions illustrated in FIG. 10 may be excluded.

As shown, the traffic monitor 1000 may include one or network interfaces 1004. The one or more network interfaces 1004 comprise suitable devices, circuits, hardware, and/or software for communicating with and/or detecting signals to/from one or more wired or wireless networks. The one or more network interfaces 304 can be used to communicate with the client device and other network-enabled devices connected either directly or indirectly to the network 112.

The processor 1010 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 1010 may comprise multiple separate physical entities that can be distributed in the traffic monitor 107. The traffic monitor 1000 can include more than one processor 1010. The processor 1010 may be connected to the one or more network interfaces 1004, the storage media comprising memory 1014, the user interface 1050, and the secure element 1090. The processor may include one or more microprocessors, microcontrollers, and/or digital signal processors that provide processing functions, as well as other calculation and control functionality. The memory 1014 is a non-transitory, processor-readable storage medium that stores can store processor-readable, processor-executable software code containing instructions that are configured to, when performed, cause the processor 1010 to perform various functions described herein. The memory 1014 may be on-board the processor 1010 (e.g., within the same IC package), and/or the memory may be external memory to the processor and functionally coupled over a data bus.

A number of software modules and data tables may reside in memory 1014 and may be utilized by the processor 1010 in order to perform the various techniques disclosed herein and/or perform device control functionality. As illustrated in FIG. 10, in some embodiments, the memory 1014 may include an anomaly detection module 1016. It is to be noted that the functionality of the modules and/or data structures may be combined, separated, and/or be structured in different ways depending upon the implementation of the traffic monitor 1000.

The anomaly detection module 1016 may be a process running on the processor 1010 of the traffic monitor 1000. The anomaly detection module 1016 can be configured to analyze traffic between the client device 108 and the relying party 120 that has been routed through the traffic monitor 1000. The anomaly detection module 1016 can be configured to analyze the attestation that accompanies a TLS handshake and/or to analyze the attestation that is provided with an access token. The anomaly detection module 1016 can be configured to perform operations similar to those of the secure communications module 226 of the client device 108. The anomaly detection module 1016 can be configured to classify traffic based on the attestation information that accompanies the TLS handshake, and can be configured to perform anomaly detection processes on the traffic. The functionality of the anomaly detection module 1016 discussed herein can also be implemented as hardware or a combination of hardware and software. The anomaly detection module 1016 can be implemented one or more application specific integrated circuits (ASICs), programmable logic devices (PLDs), field programmable gate arrays (FPGAs), or other electronic units designed to perform the functions described herein, or a combination thereof.

The processor 1010 may also include a trusted execution environment 1080. The trusted execution environment 1080 can be implemented as a secure area of the processor 1010 that can be used to process and store sensitive data in an environment that is segregated from the rich execution environment in which the operating system and/or applications (such as those of the anomaly detection module 1016) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, access tokens, and other sensitive data.

The traffic monitor 1000 may include a secure element 1090 (also referred to herein as a trusted component). The traffic monitor 1000 may include the secure element 1090 in addition to or instead of the trusted execution environment 1080. The secure element 1090 can comprise autonomous and tamper-resistant hardware that can be used to execute secure applications and the confidential data associated with such applications. The secure element 1090 can be used to store encryption keys, access tokens, and other sensitive data. The secure element 1090 can comprise a Near Field Communication (NFC) tag, a Subscriber Identity Module (SIM) card, or other type of hardware device that can be used to securely store data. The secure element 1090 can be integrated with the hardware of the traffic monitor 1000 in a permanent or semi-permanent fashion or may, in some implementations, be a removable component of the traffic monitor 1000 that can be used to securely store data and/or provide a secure execution environment for applications.

The traffic monitor 1000 may further include a user interface 1050 providing suitable interface systems, such as a microphone/speaker 1052, a keypad 1054, and a display 1056 that allows user interaction with the traffic monitor 1000. The microphone/speaker 1052 provides for voice communication services (e.g., using the one or more network interfaces 1004). The keypad 1054 may comprise suitable buttons for user input. The display 1056 may include a suitable display, such as, for example, a backlit LCD display, and may further include a touch screen display for additional user input modes. The traffic monitor 1000 may omit one or more of the user interface components discussed herein and may instead provide a wireless or wired interface for interacting with and configuring the traffic monitor 1000 from an external computing device.

The operating environment 100 may include an access server 110 and a relying party 120. The access server 110 and the relying party 120 can be configured to communicate, via a network 112 (e.g., a cellular wireless network, a WiFi network, a packet-based private or public network, such as the public Internet), or via wireless transceivers included with each respective server, with multiple network elements or nodes, and/or mobile devices. The functionality of the access server 110 and the relying party 120 can be implemented in the same server or set of servers. Furthermore, some implementations may include more than one access server 110 and/or relying party 120.

The access server 110 can be configured to generate an access token for the client device 108. The access token can be used to access applications, content, and/or services on the relying party 120 and/or other relying parties (now shown). The access server 110 can generate the access token for the client device 108 according to the various techniques disclosed herein.

The relying party 120 can comprise one or more networked devices that can be configured to provide or authorize access to applications, content, and/or services that can be accessed from the client device 108. The relying party 120 can be configured to establish a secure communication session with the client device 108 in order to access such applications, content, and/or services. The relying party 120 can also be configured to authorize the client device 108 to access applications, content, and/or services that is provided by one or more other network entities, and the relying party 120 may not provide such applications, content, and/or services to the client device 108 itself. The relying party 120 can be configured to receive an access token and attestation information from the client device 108 and to make a determination whether to establish the secure communication session with the client device based on the access token and attestation information. The relying party 120 and/or the access server 110 can be configured to include information the access token that can be used to bind one or more subsessions to a secure communication session. The relying party 120 can be configured to provide content related to online banking and/or investments, social media, payment systems, enterprise data systems, online retail, and/or other content which can include sensitive data for which access to view and/or modify the content or conduct transactions is desired.

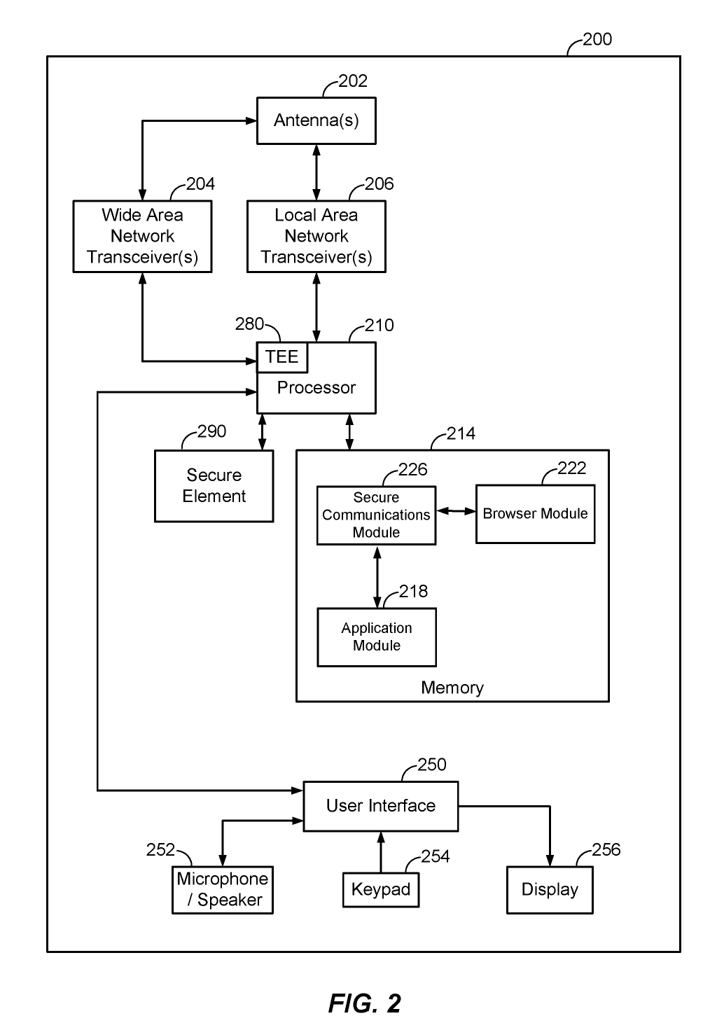

With reference now to FIG. 2, a schematic diagram illustrating various components of an example client device 200, which may be similar to or the same as the client device 108 depicted in FIG. 1 is shown. For the sake of simplicity, the various features/components/functions illustrated in the schematic boxes of FIG. 2 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded. In some embodiments, some or all of the components depicted in FIG. 2 may also be used in implementations of one or more of the LAN access points 106a-e and/or WAN access points 104a-c illustrated in FIG. 1.

As shown, the client device 200 may include one or more local area network transceivers 206 that may be connected to one or more antennas 202. The one or more local area network transceivers 206 comprise suitable devices, circuits, hardware, and/or software for communicating with and/or detecting signals to/from one or more of the LAN access points 106a-e depicted in FIG. 1, and/or directly with other wireless devices within a network. In some embodiments, the local area network transceiver(s) 206 may comprise a WiFi (802.11x) communication transceiver suitable for communicating with one or more wireless access points; however, in some embodiments, the local area network transceiver(s) 206 may be configured to communicate with other types of local area networks, personal area networks (e.g., Bluetooth® wireless technology networks), etc. Additionally, any other type of wireless networking technologies may be used, for example, Ultra Wide Band, ZigBee, wireless USB, etc.

The client device 200 may also include, in some implementations, one or more wide area network transceiver(s) 204 that may be connected to the one or more antennas 202. The wide area network transceiver 204 may comprise suitable devices, circuits, hardware, and/or software for communicating with and/or detecting signals from one or more of, for example, the WAN access points 104a-c illustrated in FIG. 1, and/or directly with other wireless devices within a network. In some implementations, the wide area network transceiver(s) 204 may comprise a CDMA communication system suitable for communicating with a CDMA network of wireless base stations. In some implementations, the wireless communication system may comprise other types of cellular telephony networks, such as, for example, TDMA, GSM, WCDMA, LTE etc. Additionally, any other type of wireless networking technologies may be used, including, for example, WiMax (802.16), etc.

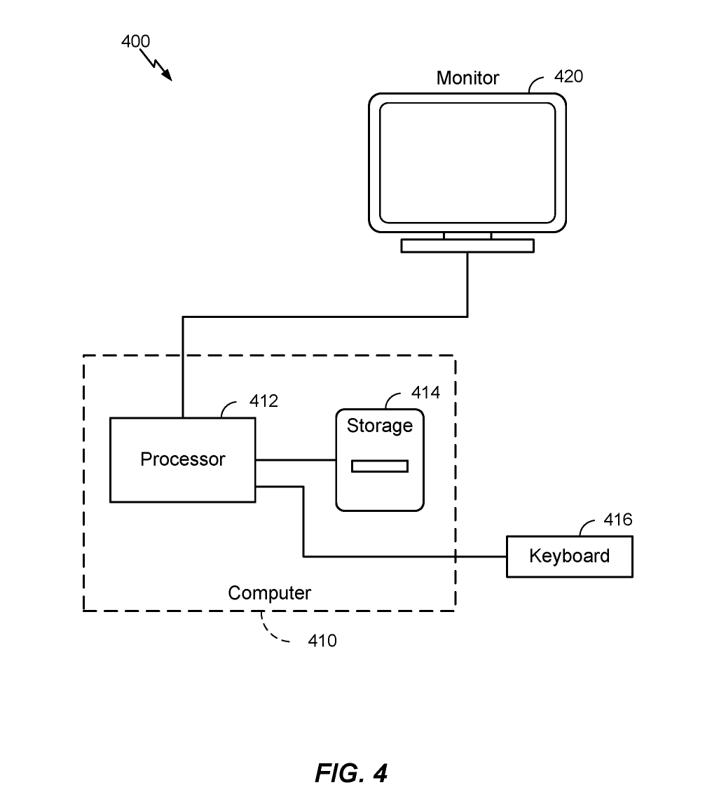

The processor(s) (also referred to as a controller) 210 may be connected to the local area network transceiver(s) 206 and the wide area network transceiver(s) 204. The processor may include one or more microprocessors, microcontrollers, and/or digital signal processors that provide processing functions, as well as other calculation and control functionality. The processor 210 may be coupled to storage media (e.g., memory) 214 for storing data and software instructions for executing programmed functionality within the mobile device. The memory 214 may be on-board the processor 210 (e.g., within the same IC package), and/or the memory may be external memory to the processor and functionally coupled over a data bus. Further details regarding an example embodiment of a processor or computation system, which may be similar to the processor 210, are provided below in relation to FIG. 4.

A number of software modules and data tables may reside in memory 214 and may be utilized by the processor 210 in order to manage both communications with remote devices/nodes (such as the various nodes, the access server 110, and/or the relying party 120 depicted in FIG. 1), and/or perform device control functionality. As illustrated in FIG. 2, in some embodiments, the memory 214 may include an application module 218, a browser module 222, and a secure communications module 226. It is to be noted that the functionality of the modules and/or data structures may be combined, separated, and/or be structured in different ways depending upon the implementation of the client device 200.

The application module 218 may be a process running on the processor 210 of the client device 200, which may request data from one of the other modules of the client device 200. Applications typically run within an upper layer of the software architectures and may be implemented in a rich execution environment of the client device 200, and may include indoor navigation applications, shopping applications, financial services applications, social media applications, location aware service applications, etc. The applications of the application module 218 may make use of the access token to obtain content and/or services from the relying party 120 or to have the relying party authorize access to content and/or services, which may be provided by another network entity or entities. The application module 218 can also be configured to request access to content and/or services from the relying party 120 where other types of authentication may be used instead of an access token. The application module 218 can be an application that provides content related to online banking and/or investments, social media, payment systems, enterprise data systems, online retail, and/or other content which can include sensitive data for which access to view and/or modify the content or conduct transactions is desired. The application module 218 can be configured to obtain content to be used by the application module 218 from the relying party 120.

The secure communications module 226 may be a process running on the processor 210 of the client device 200, which may generate requests for access tokens from the access server 110. The secure communications module 226 can also be configured to manage the storage of and access to the access tokens, encryption keys, and attestation information. The secure communications module 226 may be executed on a processor component of the trusted execution environment 280 and/or the secure element 290, where the client device 200 includes such components. The functionality of the secure communications module 226 discussed herein can also be implemented as hardware or a combination of hardware and software. The secure communications module 226 can be implemented one or more application specific integrated circuits (ASICs), programmable logic devices (PLDs), field programmable gate arrays (FPGAs), or other electronic units designed to perform the functions described herein, or a combination thereof. At least a portion of the functionality of the secure communications module 226 can be implemented in the hardware and/or software of the as the one or more local area network transceivers 206 or the one or more wide area network transceivers 204. For example, at least a portion of the functionality of the secure communications module 226 can be implemented in the hardware and/or software of the as the one or more local area network transceivers 206 or the one or more wide area network transceivers 204 that implement one or more network protocol stacks that can be used for communicating with other network entities.

The browser module 222 can be configured to provide a user interface the allows for content from the relying party 120 and/or other network-enabled content providers to be accessed and displayed on the client device 108. The browser module 222 can be configured to route the requests for content through the traffic monitor 107. The browser module 222 can be configured not to route requests for content to the traffic monitor 107 in other implementations where a traffic monitor 107 is not present or to route a subset of request through the traffic monitor 107 where the traffic monitor 107 is present.

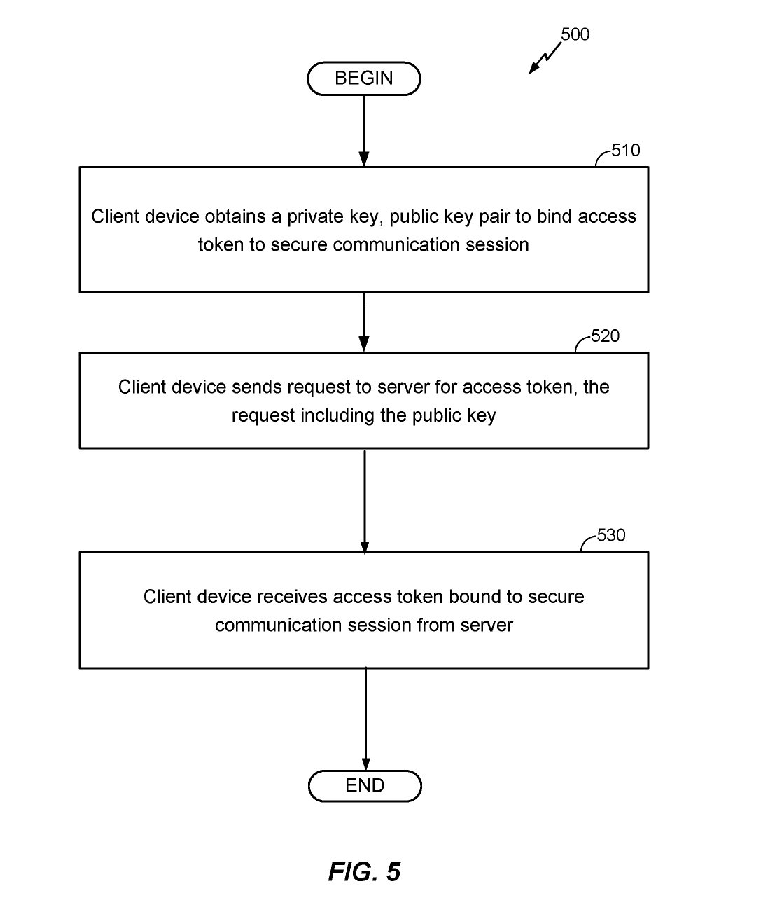

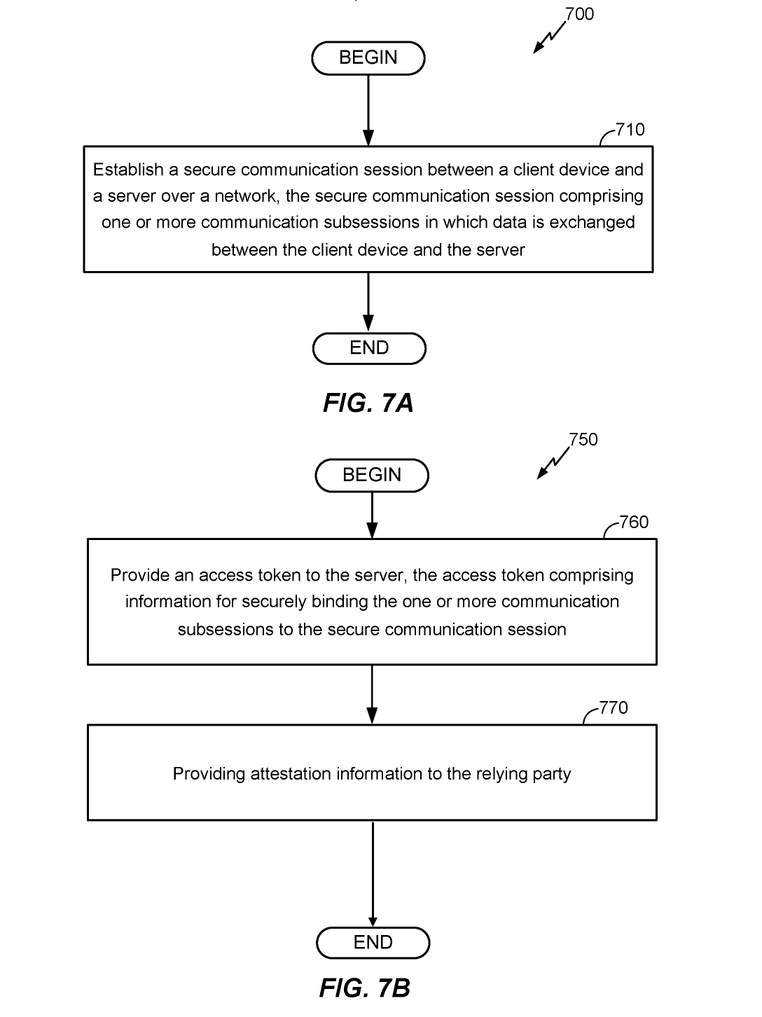

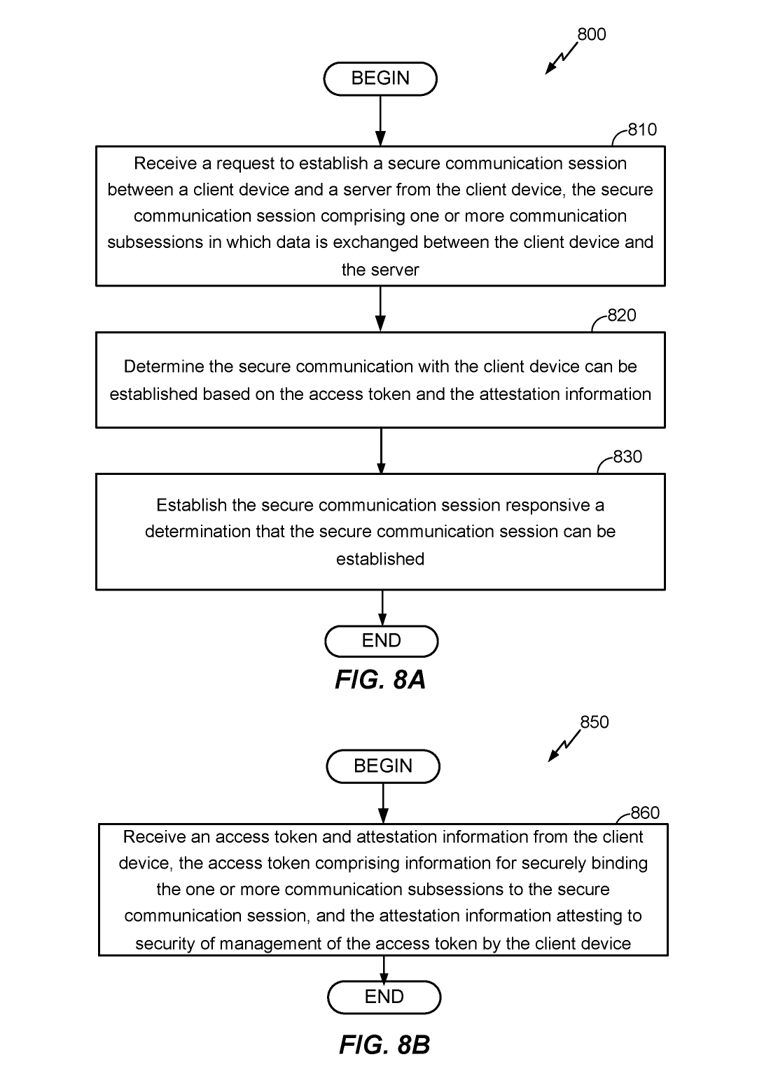

The secure communications module can be used to implement the client-side process illustrated in FIG. 5 for obtaining an access token, and the client-side processes illustrated in FIGS. 7A, 7B, 9, 11, and 12 for establishing a secure communication session with the relying party 120, unless otherwise indicated.

The processor 210 may also include a trusted execution environment 280. The trusted execution environment 280 can be implemented as a secure area of the processor 210 that can be used to process and store sensitive data in an environment that is segregated from the rich execution environment in which the operating system and/or applications (such as those of the application module 218) may be executed. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, access tokens, and other sensitive data.

The client device 200 may include a secure element 290 (also referred to herein as a trusted component). The client device 200 may include the secure element 290 in addition to or instead of the trusted execution environment 280. The secure element 290 can comprise autonomous and tamper-resistant hardware that can be used to execute secure applications and the confidential data associated with such applications. The secure element 290 can be used to store encryption keys, access tokens, and other sensitive data. The secure element 290 can comprise a Near Field Communication (NFC) tag, a Subscriber Identity Module (SIM) card, or other type of hardware device that can be used to securely store data. The secure element 290 can be integrated with the hardware of the client device 200 in a permanent or semi-permanent fashion or may, in some implementations, be a removable component of the client device 200 that can be used to securely store data and/or provide a secure execution environment for applications.

The client device 200 may further include a user interface 250 providing suitable interface systems, such as a microphone/speaker 252, a keypad 254, and a display 256 that allows user interaction with the client device 200. The microphone/speaker 252 provides for voice communication services (e.g., using the wide area network transceiver(s) 204 and/or the local area network transceiver(s) 206). The keypad 254 may comprise suitable buttons for user input. The display 256 may include a suitable display, such as, for example, a backlit LCD display, and may further include a touch screen display for additional user input modes.

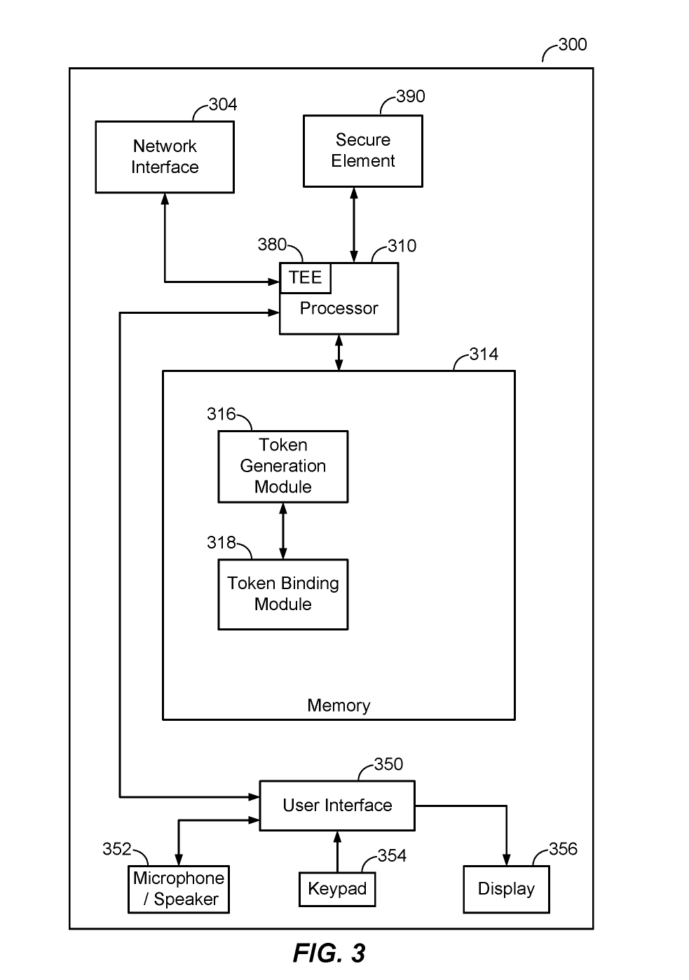

With reference now to FIG. 3, a schematic diagram illustrating various components of an example server 300, which may be similar to or the same as the access server 110 or relying party 120 depicted in FIG. 1 is shown. For the sake of simplicity, the various features/components/functions illustrated in the schematic boxes of FIG. 3 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

As shown, the server 300 may include one or network interfaces 304. The one or more network interfaces 304 comprise suitable devices, circuits, hardware, and/or software for communicating with and/or detecting signals to/from one or more wired or wireless networks. The one or more network interfaces 304 can be used to communicate with the client device via the network 112.

The processor(s) (also referred to as a controller) 310 may be connected to the one or more network interfaces 304, the storage media comprising memory 314, the user interface 350, and the secure element 390. The processor may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus. Further details regarding an example embodiment of a processor or computation system, which may be similar to the processor 310, are provided below in relation to FIG. 4.

A number of software modules and data tables may reside in memory 314 and may be utilized by the processor 310 in order to manage both communications with remote devices/nodes, perform positioning determination functionality, and/or perform device control functionality. As illustrated in FIG. 3, in some embodiments, the memory 314 may include a token generation module 316 and/or a token binding module 318. It is to be noted that the functionality of the modules and/or data structures may be combined, separated, and/or be structured in different ways depending upon the implementation of the server 300. Furthermore, The functionality of the token generation module 316 and/or a token binding module 318 discussed herein can also be implemented as hardware or a combination of hardware and software. The token generation module 316 and/or a token binding module 318 can be implemented one or more application specific integrated circuits (ASICs), programmable logic devices (PLDs), field programmable gate arrays (FPGAs), or other electronic units designed to perform the functions described herein, or a combination thereof.

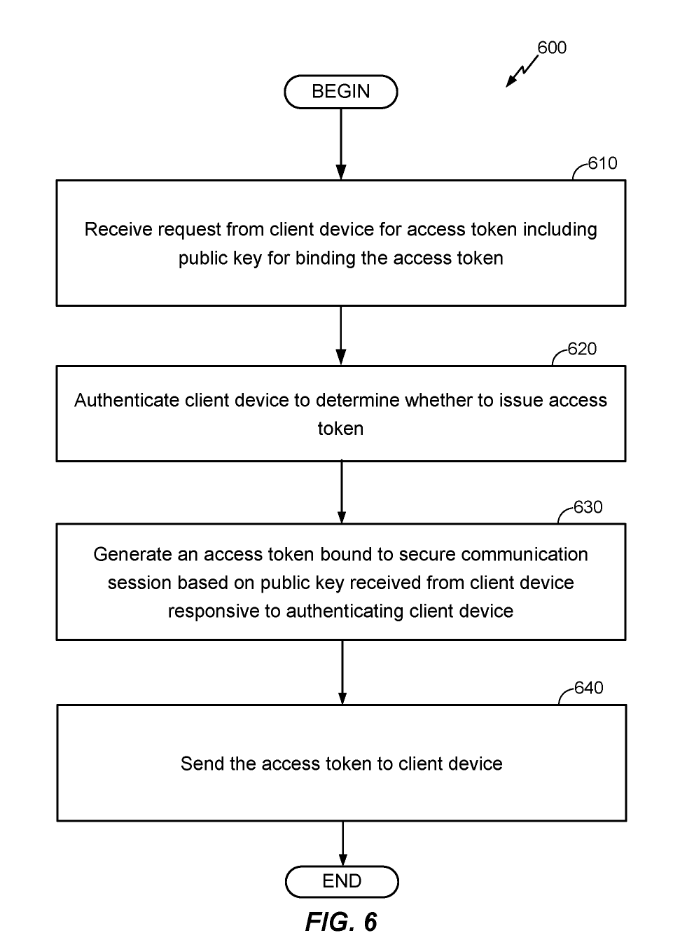

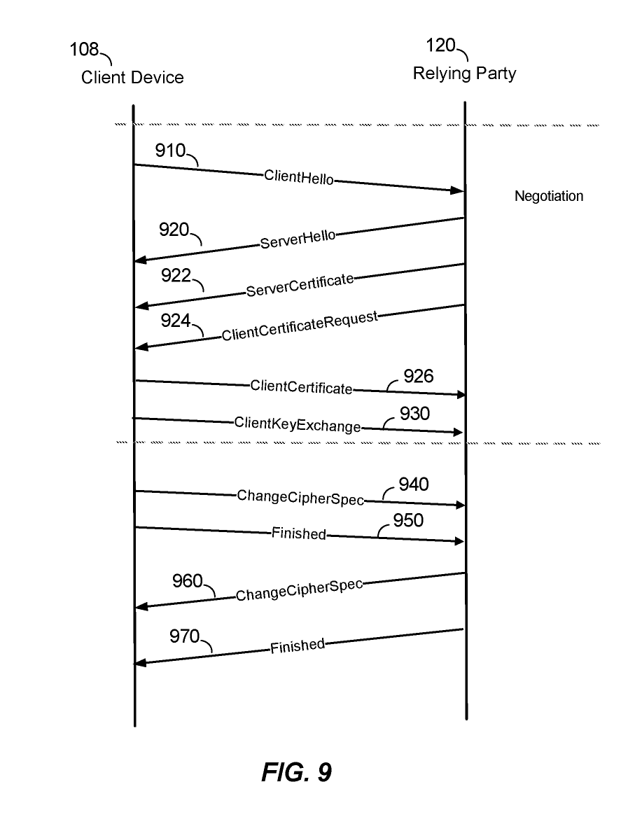

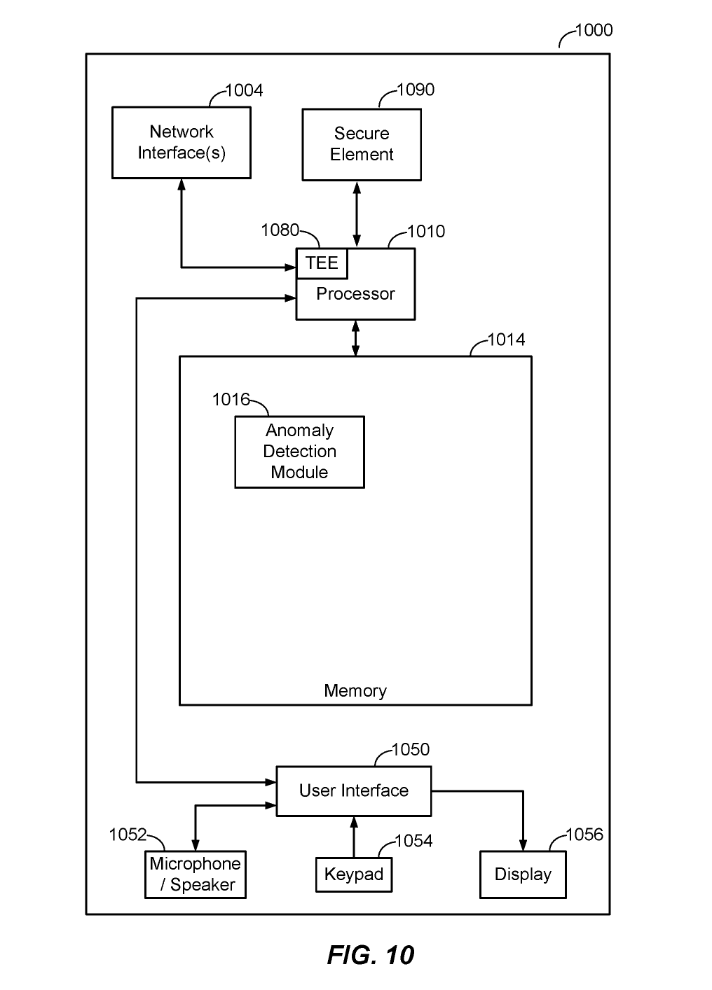

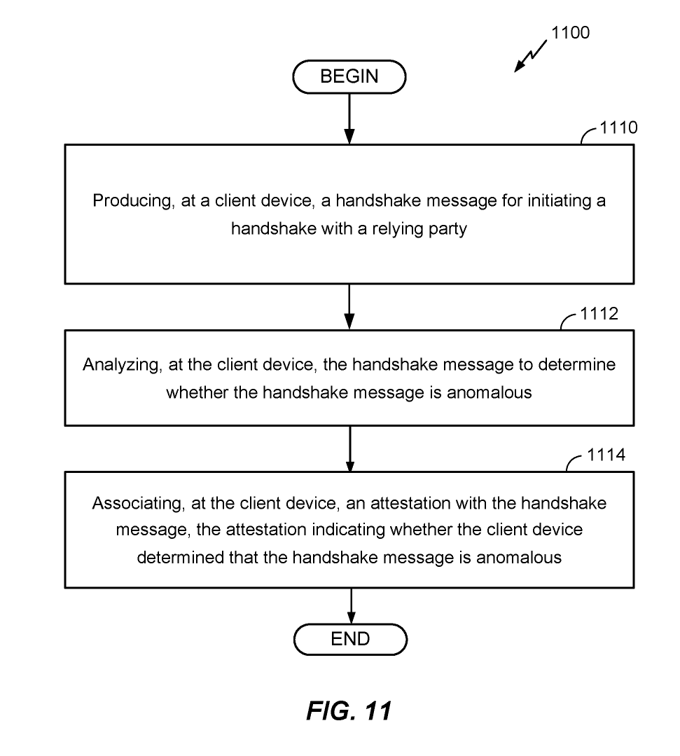

The token generation module 316 may be a process running on the processor 310 of the server 300, which may generate an access token for a client device 108 according to the various techniques disclosed herein. The token binding module 318 may be a process running on the processor 310 of the server 300, which can use information included in the access token to securely bind the access token to a secure communication session associated with the client device 108, according to the various techniques disclosed herein. For example, the token generation module 316 and the token binding module 318 can be used to implement the server-side process illustrated in FIG. 6 for generating an access token and for using information included in the access token to securely bind one or more communication subsessions to a secure communication session and the server-side processes illustrated in FIGS. 8A, 8B, and 9 for establishing a secure communication session with the client device 108, unless otherwise indicated.

The processor 310 may also include a trusted execution environment 380. The trusted execution environment 380 can be implemented as a secure area of the processor 310 that can be used to process and store sensitive data in an environment that is segregated from the rich execution environment in which the operating system and/or applications (such as those of the application module 218) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, access tokens, and other sensitive data.

The server 300 may include a secure element 390 (also referred to herein as a trusted component). The server 300 may include the secure element 390 in addition to or instead of the trusted execution environment 380. The secure element 390 can comprise autonomous and tamper-resistant hardware that can be used to execute secure applications and the confidential data associated with such applications. The secure element 390 can be used to store encryption keys, access tokens, and other sensitive data. The secure element 390 can comprise a Near Field Communication (NFC) tag, a Subscriber Identity Module (SIM) card, or other type of hardware device that can be used to securely store data. The secure element 390 can be integrated with the hardware of the server 300 in a permanent or semi-permanent fashion or may, in some implementations, be a removable component of the server 300 that can be used to securely store data and/or provide a secure execution environment for applications.

The server 300 may further include a user interface 350 providing suitable interface systems, such as a microphone/speaker 352, a keypad 354, and a display 356 that allows user interaction with the server 300. The microphone/speaker 352 provides for voice communication services (e.g., using the one or more network interfaces 304). The keypad 354 may comprise suitable buttons for user input. The display 356 may include a suitable display, such as, for example, a backlit LCD display, and may further include a touch screen display for additional user input modes.

Performing the procedures described herein may be facilitated by a processor-based computing system. With reference to FIG. 4, a schematic diagram of an example computing system 400 is shown. The computing system 400 may be housed in, for example, a handheld mobile device such as the client device 108 and client device 200 of FIGS. 1 and 2, respectively, or may comprise part or all of access server 110, relying party 120, and server 300, nodes, access points, or base stations such as the WAN access points 104a-c and 106a-e depicted in FIGS. 1 and 3. The computing system 400 includes a computing-based device 410 such as a personal computer, a specialized computing device, a controller, and so forth, that typically includes a central processor unit (CPU) 412. In addition to the CPU 412, the system includes main memory, cache memory and bus interface circuits (not shown). The computing-based device 410 may include a mass storage device 414, such as a hard drive and/or a flash drive associated with the computer system. The computing system 400 may further include a keyboard, or keypad, 416, and a monitor 420, e.g., a CRT (cathode ray tube) or LCD (liquid crystal display) monitor, that may be placed where a user can access them (e.g., a mobile device's screen).

The computing-based device 410 may be configured to facilitate, for example, the implementation of one or more of the procedures described herein (including the procedures to disseminate, collect, and/or and manage antenna information, the procedures to perform location determination operations, etc.) The mass storage device 414 may thus include a computer program product that when executed on the computing-based device 410 causes the computing-based device to perform operations to facilitate the implementation of the procedures described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), a DSP processor, or an ASIC (application-specific integrated circuit) may be used in the implementation of the computing system 400. Other modules that may be included with the computing-based device 410 are speakers, a sound card, a pointing device, e.g., a mouse or a trackball, by which the user can provide input to the computing system 400. The computing-based device 410 may include an operating system.

FIG. 5 is a flow diagram of an example process 500 in which a client device can obtain an access token from an access server. The process 500 can be implemented by the client device 108 illustrated in FIG. 1 or the client device 200 illustrated in FIG. 2. The access token can be bound to a secure communication session such that a malicious party obtaining the access token would not be able to utilize the access token without also obtaining a private key stored on the client device 108. The private key can be stored in a memory associated with the trusted execution environment 280 or the secure element 290 of the client device 108 to prevent malicious parties from obtaining the private key. The access token, once obtained, may also be stored in the memory associated with the trusted execution environment 280 or the secure element 290 of the client device 108 as well. The client device 108 can be configured to provide attestation information to the relying party 120 in addition to the access token when attempting to obtain access to applications, content, and/or services provided by the relying party 120. The attestation information can provide information regarding the management of the private keys by the client device 108, and the relying party 120 can make a determination whether to establish a secure communication session with the client device 108 based on the access token and the attestation information. Examples of processes illustrated in FIGS. 7A, 7B, 8A, 8B, and 9 illustrate these concepts and are discussed in detail below.

Returning now to FIG. 5, the client device 108 can obtain a private key-public key pair that can be used to bind an access token to a secure communication session (stage 510). The client device 108 can be configured to generate the private key-public key pair to be used for a particular secure communication session. The client device 108 can be configured to generate the private key-public key pair in the trusted execution environment 280 or the secure element 290 of the client device 108 to help ensure that the private key remains secret. In some implementations, the client device 108 may generate the private key in a rich execution environment in which the operating system and non-trusted applications may be executed by the client device 108 if the client device lacks a trusted execution environment 280 or a secure element 290. The attestation information provided by the client device 108 with the access token can indicate whether the private key-public key pair was generated and stored in a trusted execution environment 280 or a secure element 290, and the relying party 120 can use this management information to determine whether to establish a secure communication session with the client device 108.

The client device 108 can send a request to the access server 110 for an access token that can be used to access applications, content, and/or services provided by the relying party 120 (stage 520). The request can include the public key obtained in stage 510. The private key of the key pair should be maintained as a secret by the client device 108. The public key of the key pair can be used by the access server 110 to bind the access token to the secure communication session. The actions that may be taken by the access server 110 when generating the access token are discussed in detail below with regard to the process 600 illustrated in FIG. 6.

The client device 108 can receive the access token from the access server 110 (stage 530). The client device 108 can be configured to store the access token in a memory associated with the trusted execution environment 280 or the secure element 290 of the client device 108 to help prevent the theft of the access token by a malicious third party. However, the client device 108 may be configured to store the access token in a memory accessible by the rich execution environment while maintaining the private key associated with the access token in the memory associated with the trusted execution environment 280 or the secure element 290. In some implementations, the client device 108 may store the access token and/or the encryption keys in an rich execution environment. However, the client device 108 can be configured to encrypt or otherwise encode the access token and/or the encryption keys in an rich execution environment to prevent unauthorized access to the access token and the private key associated with the access token.

FIG. 6 is a flow diagram of an example process 600 in which a client device can obtain an access token from an access server. The process 600 can be implemented by the access server 110 illustrated in FIG. 1 or server 300 illustrated in FIG. 3. As discussed above, the functionality of the access server 110 and the relying party 120 can be implemented in the same server or set of servers in some implementations.

The access server 110 can receive a request from the client device 108 (or client device 200) for an access token (stage 610). The request can include a public key from a private key-public key pair obtained by the client device 108 which is associated with a secure communication session to which the access token is to be bound. Binding the access token to the secure communication session using the public key means that a client device 108 requires both the access token and the private key associated with the public key used to bind the access token in order for the client device 108 to be able to establish a secure communication session with the relying party 120 using the access token.

The access server 110 can authenticate the client device 108 to determine whether to issue the access token (stage 620). The request received from the client device 108 can include information that can be used to identify the client device 108 to the access server 110. For example, the request may be signed by a private key associated with the client device 108 and/or a private key associated with the trusted execution environment 280 or the secure element 290 of the client device 108. The request may also include authentication credentials, such as a username and password combination, or other information that the access server 110 can use to authenticate the client device 108. The access server 110 can be configured to authenticate the client device 108 with respect to a specific relying party 120 or application, content, and/or service provided by that relying party 120. Furthermore, the access server 110 can also be configured to authenticate the user with respect to more than one relying party 120. In some embodiments, the access server 110 may issue separate access tokens to the client device 108 for each relying party 120, and the client device 108 can use each access token to establish a secure communication session with a particular relying party 120. In other embodiments, the access server 110 may issue an access token that may be used to establish a secure communication session with more than one relying party 120.

The access server 110 can generate an access token which is bound to a particular secure communication session based on the public key received from the client device 108 responsive to authenticating the client device 108 (stage 630). The access server 110 can be configured to incorporate the public key into the access token and/or to sign the access token using the public key provided by the client device 108. The access server 110 can also be configured to incorporate an identifier into the access token that can be mapped to the client device 108 and/or the private key associated with the client device 108 is associated with the public key. For example, the access server 110 can encrypt information using the public key provided by the client device 108 and insert the encrypted information into the token. The access server 110 can also be configured to store the unencrypted of the information in a database that maps the unencrypted information to the access token and the client device 108. The access server 110 can make this database accessible to the relying party 120. The client device 108 can later prove to the relying party 120 that the relying party 120 possesses the private key from the private key-public key pair used to generate the access token by decrypting the encrypted information included in the token and providing the unencrypted information to the relying party 120. This information does not need to be send in the clear over the network 112, which could impact the security of the access token. Instead, the client device 108 can be configured to encrypted the decrypted information using a public key associated with the relying party 120 before sending the information to the relying party 120. The relying party 120 can decrypt the information provided by the client device 108 using the relying party's private key, and the relying party can compare the information provided by the client server that the client device 108 extract from the token to the unencrypted data in the database maintained by the access server 110 to determine whether the client device 108 is in possession of the private key. The access server 110 and the relying party 120 can provide a secure interface for communicating the access token information over the network 112 so that the security of the token information is not compromised. The relying party 120 can also be configured to use the public key included in the access token to encrypt a nonce value each time that the client device 108 attempts to establish a subsession connection associated with a secure communication session with the relying party 120. The relying party 120 can be configured encrypt the nonce value with the public key included in the access token and to send the encrypted nonce value to the client device 108. The client device 108, upon receiving the encrypted nonce value, can decrypt the encrypted nonce value using the appropriate private key maintained by the client device 108. The client device 108 can then return the encrypted nonce value to the relying party 120. The client device 108 may re-encrypt the nonce value with a public key of the relying party 120 before sending the nonce value back to the relying party 120. If the client device 108 cannot decrypt the encrypted nonce value, the relying party 120 can be configured to halt the secure communication session with the client device 108.

The access server 110 can send the access token to the client device 108 over the network 112 (stage 640). The access server 110 can send the access token to the client device 108 over the public network, because both the token and the private key held by the client device 108 should be required in order for the access token to be used to obtain access to content, services, and/or services provided by the relying party 120. The access server 110 can also be configured to encrypt the access token prior to sending the access token to the client device 108. For example, the access server 110 can be configured to encrypt the access token using a public key associated with the client device 108, which may be different than the public key used to bind the token to the secure communication session, and send the encrypted token to the client device 108. The client device 108 can then use the appropriate private key to decrypt the encrypted access token.

FIG. 7A is a flow diagram of an example process 700 in which a client device can establish a secure communication session with a relying party. The process illustrated in FIG. 7B is a flow diagram of an example process which includes stages which can be used to implement stage 710 of the process 700 illustrated in FIG. 7A. The processes illustrated in FIGS. 7A and 7B can be implemented by the client device 108 unless otherwise specified. The secure communication subsession can be a Transport Layer Security (TLS) protocol communication session or can be other types of secure communication subsession where the client device 108 can provide attestation information along with an access token or other security credentials to the relying party 120, and the attestation information can provide information about the client device 108 to the relying party 120 and information as to how the client device 108 manages the access token or other security credentials.

The client device 108 can establish a secure communication session between a client device and a relying party 120 over a network (stage 710). The secure communication session can include one or more communication subsessions in which data is exchanged between the client device 108 and the relying party 120. Data exchanged between the client device 108 and the relying party 120 can be encrypted using various encryption techniques. The client device 108 and the relying party 120 can be configured to undertake a negotiation process as part of stage 710 in which the client device 108 and the relying party 120 exchange information regarding the encryption capabilities of the client device 108 and the relying party 120. During this negotiation process, the client device 108 and the relying party 120 can exchange information that can be used to generate the encryption keys that can be used by the client device 108 and the relying party 120 to encrypt data to be exchanged during the secure communication session. The client device 108 and the relying party 120 can also be configured to determine a cipher suite to be used to encrypt the communications between the client device 108 and the relying party 120 during the secure communication session during the negotiation process. The client device 108 and the relying party 120 can also be configured to perform additional actions in addition to and/or instead of one or more of the actions discussed herein during negotiation phase in which the secure communication session is established.

The client device 108 can be configured to select an appropriate cipher suite to be used for encrypting communications with the relying party 120 based on an estimated lifespan of the communication subsessions to be associated with the secure communication session. The client device 108 can be configured to select a technique for signing the access token and/or for performing other cryptographic operations that the client device 108 should be able to complete within the estimated lifespan of the communication subsession. A subsession connection may be fleeting and the cryptographic operations performed on data exchanged for such a subsession connection should be able to completed within the estimated lifespan of such as connection. The client device 108 can also be configured to receive policy information from the server during the negotiation phase that indicates preferred encryption techniques to be used for signing data and/or other cryptographic operations and to select an appropriate cryptographic technique or techniques based on the server policy information.

The client device 108 can provide an access token and attestation information associated with the access token to the relying party 120 during stage 710. Information included in the access token can be used to bind the secure communication session to the client device 108. FIGS. 5 and 6 illustrate example processes in which an access token may be bound to a secure communication session. In some implementations, the client-side process illustrated in FIG. 5 may be included in stage 710 of the process illustrated in FIG. 7A, and the client device 108 may obtain the access token from the access server 110, and the access token can then be associated with secure communication identifier by the access server 110. The binding process can use a public key uniquely associated with the client device 108 that can be used to ensure that the access token can only be used by client device 108, which is in possession of the private key corresponding to the public key used to bind the access token. The example binding processes illustrated herein are examples of some of the types of binding processes that may be used to bind the access token to the secure communication session and are not intended to limit the techniques disclosed herein to such processes. The client device 108 can also provide attestation information that can provide information about that client device 108 and how the client device manages the access token and the private keys. The attestation information is discussed in detail below with respect to FIG. 7B.

Stages 760 and 770 of the process 750 illustrated in FIG. 7B can be used to implement at least a portion of stage 710 of the process 700 illustrated in FIG. 7A. The client device 108 can be configured to provide an access token to the server (stage 760). Information included in the access token can be used to securely bind the one or more communication subsessions to the secure communication session. The access token can be issued by the access server 110 discussed above. The access token can be used to bind one or more communication subsessions to a secure communication session to ensure that a malicious third party cannot obtain the token and attempt to access content on the relying party 120 using the access token. The access token can be bound to the secure communication session in multiple ways. One way that the access token may be bound to the secure communication session is to generate the access token prior to or as the secure communication session being established and to incorporate into the access token a unique identifier associated with the secure communication session, such a public key associated with the client device 108. The access token can also be mapped to a unique identifier associated with the secure communication session and the mapping can be stored in a database that the relying party 120 can access whenever the client device 108 attempts to establish a communication subsession associated with the secure communication session with the relying party 120.

FIGS. 5 and 6 discussed above provide an example of client-side and server-side processes that may be used to bind the secure communication session with the access token. According to the processes discussed in FIGS. 5 and 6, the access token can be associated with the client device 108 utilizing the public key of a private key-public key pair associated with the client device 108. The client device 108 ideally stores the private key in a memory associated with the trusted execution environment 280 or the secure element 290. The client device 108 must possess bot the access token and the associated private key in order to make use of the access token to establish a secure communication session with the relying party 120.

The client device 108 can also be configured to provide attestation information to the relying party 120 (stage 770). The attestation information can attest to security of management of the access token by the client device 108. The client device 108 can take various measures to securely manage the private keys associated with the client device 108 and the access tokens utilized by the client device 108. As discussed above, some client device 108 may include a trusted execution environment or trusted component, and the client device 108 can be configured to store private keys and the access tokens used by the client device 108 in a memory associated with the trusted execution environment or trusted component to decrease the likelihood of a malicious third party obtaining these private keys and access tokens, and using these keys and access tokens to impersonate an authorized user to obtain access to applications, content, and/or services provided by the relying party 120. The attestation information can give the relying party 120 information about the client device 108 and how the client device 108 manages the private keys and access tokens used by the client device 108. The relying party 120 can use the attestation information to determine whether to establish a secure communication session with the client device 108.

The attestation information can include information indicating whether the access tokens and the private keys are stored in memory associated with a trusted execution environment or trusted component of the client device 108. The attestation information can also include other information about the client device 108, such as the hardware and/or firmware information about the client device 108, operating system version information, information identifying trusted applications installed on the client device 108 that utilize the trusted execution environment or trusted component of the client device 108, information identifying applications installed on the client device 108 that do not operate in the rich execution environment, and/or version information for trusted and untrusted applications.

In some implementations, the client device 108 can provide multi-layered attestation information to the relying party 120. In some implementations, the client device 108 can provide attestation information at an application layer and at a socket layer. The attestation information provided at the application layer and the socket layer can potentially differ, and the relying party 120 can be configured to make a determination whether to allow the secure communication session to be established based on the application layer and the socket layer attestation information. For example, an application on the client device 108, such as a web browser or other application configured to establish a secure communication session with the relying party 120, may be configured to provide application layer attestation information.

FIG. 8A is a flow diagram of an example process 700 in which a server can establish a secure communication session with a client device. The process illustrated in FIG. 8B is a flow diagram of an example process which includes stages which can be used to implement stage 810 of the process 800 illustrated in FIG. 8A. The process illustrated in FIGS. 7A and 7B can be implemented by the relying party 120 and/or by the access server 110 unless otherwise specified.

The relying party 120 can receive a request from the client device 108 to establish a secure communication session between the client device 108 and the relying party 120 (stage 810). The secure communication session can include one or more communication subsessions in which data is exchanged between the client device 108 and the relying party 120. The secure communication subsession can be a Transport Layer Security (TLS) protocol communication session or can be other types of secure communication subsession where the client device 108 can provide attestation information along with an access token or other security credentials to the relying party 120, and the attestation information can provide information about the client device 108 to the relying party 120 and information as to how the client device 108 manages the access token or other security credentials. FIG. 8B illustrates a process that can be used to implement at least a portion of stage 810 in which the relying party 120 receives an access token and attestation information from the client device 108.

The relying party 120 can determine whether the secure communication session can be established with the client device 108 based on information provided by the client device 108 (stage 820). The relying party 120 can make the determination whether the secure communication session can be established based on the access token and the attestation information received from the client device 108. With respect to the access token, the relying party 120 can be configured to determine whether the access token is bound to a secure communication session or is a generic bearer token that is not bound to a particular secure communication session. The relying party can access policy information associated with applications, content, and/or services to which the access token would provide access to determine whether the access token is required to be bound to a particular secure communication session. If the policy indicates that the access token must be bound to a secure communication session, and the token is unbound, the relying party 120 can be configured to terminate the secure communication session. If the access token is bound to a secure communication session, the relying party 120 can compare a token ID in the token with a session ID associated with the secure communication session. If the token ID and the session ID differ, the relying party 120 may determine that the access token is not in the possession of the client device 108 to which it was issued and can terminate the secure communication session. The access token may also include information encrypted using a public key of the client device 108. The relying party 120 can be configured to obtain an unencrypted version of this information from the access server 110, which issued the encryption token, and an unencrypted version of this string from the client device 108. If the unencrypted version obtained from the client device 108 is the same as that obtained from the access server 110, then the client device 108 is in possession of the private key associated with the public key that was bound to the access token. If the unencrypted version provided by the client device 108 does not match that obtained from the access server 110, the relying party 120 can be configured to terminate the secure communication session. The relying party 120 can be configured to perform additional processing with respect to the access token to determine whether the establish the secure communication session with the client device 108 in addition to or instead of one or more of those discussed herein.

The relying party 120 can also be configured base the determination on whether the secure communication session can be established based on the attestation information provided by the client device 108. The attestation information can provide information regarding the configuration of the hardware and/or the software of the client device 108, including versions of the software and firmware utilized by the client device 108. The attestation information can also include information such as the types and version of secure communication protocols and encryption protocols supported by the client device. The relying party 120 can compare the attestation information to the policy information associated with the application-specific policy information to determine whether to allow access to the applications, content, and/or services provided by the relying party 120. The application-specific policy information can include rule related to the hardware and/or software of the client device 108. For example, the policy rules may prohibit establishing a secure communication session with certain types of client device 108 where the hardware does not provide a trusted execution environment 280, a secure element 290, or other secure environment for storing the encryption keys and/or the access tokens. The policy rules may also require that the client device 108 have a certain version number or higher or a particular patch for the operating system software installed on the client device 108, because those version numbers or the patch have fixed a security issue with the operating system of the client device 108. The policy rules may also require that the client device 108 not have certain software applications or versions of software applications installed that are known to pose a security threat or outdated versions.

At least a portion of the attestation information may be encrypted using a private key associated with the client device 108 and/or with a trusted execution environment and/or the secure element 290 of the mobile device. The relying party 120 can use the corresponding public key associated with the client device 108 to decrypt the encrypted portion of the attestation information, which can be used to confirm that the client device 180 is in possession of the private key. If the relying party 120 cannot decrypt the encrypted content, then the client device 108 may not be in possession of the private key associated with the access token, and the relying party 120 can be configured to terminate the secure communication session with the client device 108.

The relying party 120 can also be configured to make a determination as whether to establish the secure communication session with the client device 108 based on assertions made by the client device 108 regarding the management of the access token and/or the private keys on the client device 108. For example, the relying party 120 may determine that the policy information requires that the client device 108 store the private keys and/or attestation tokens in a secure memory location such as in the trusted execution environment 280 or the secure element 290, and the relying party 120 may terminate a session with the client device 108 if the client device 108 does not assert that the encryption keys and/or the access tokens have been stored in such a secure memory location.

The relying party 120 can also be configured obtain information from the local data, from the access server 110, or another third party server (not shown) that can be used to confirm various aspects of the attestation information provided by the client device 108 and/or to obtain additional information that can be used to make a determination. For example, the relying party 120 can be configured to obtain hardware and/or firmware specifications for the type of device used to implement the client device 108 to determine whether the device provides the appropriate level of hardware and/or software security for storage and management of the private keys and/or the access tokens. The relying party 120 may also be able to obtain additional information from the access server 110 which can be used to confirm the assertions made by the client device 108 in the attestation information. The relying party 120 may also obtain other information about the client device 108 from these or other sources to determine whether the secure communication session can be established by the client device.

The relying party 120 can establish the secure communication session with the client device 108 responsive to determining that the secure communication session can be established (stage 830). If the relying party 120 determines that the secure communication session cannot be established for any reason, the relying party 120 can be configured to tear down the secure communication session between the client device 108 and the relying party 120. The relying party 120 can also be configured to send a message to the client device 108 indicating that the secure communication session could not be established. The client device 108 can be configured to receive and process this message and may be configured to provide an error message to a user of the client device 108 via a user interface of the client device indicating that the secure communication session could not be established.

Stage 860 of the process 850 illustrated in FIG. 8B can be used to implement at least a portion of stage 810 of the process 800 of FIG. 8A. The relying party 120 can receive an access token and attestation information from the client device 108 (stage 860). The access token can securely bind the one or more communication subsessions to the secure communication session, and the attestation information can attest to the security management of the access token by the client device 108. As discussed above, the access token may be generated by a separate access server 110 or the functionality of the access server 110 may be incorporated into the relying party 120 and the relying party 120 may generate the access token and bind it to the secure communication session as the secure communication session is established. The attestation information can attest to security of management of the access token by the client device 108. The attestation information can give the relying party 120 information about the client device 108 and how the client device 108 manages the private keys and access tokens used by the client device 108. The relying party 120 can use the attestation information to determine whether to establish a secure communication session with the client device 108.

FIG. 9 is a signal flow diagram illustrating example interactions between a client device and relying party according an example implementation. The example illustrated in FIG. 9 can be used to implement stage 710 of the FIG. 7A, stages 760 and 770 of FIG. 7B, the stages of the processes illustrated in FIGS. 8A and 8B. In the example illustrated in FIG. 9, the client device 108 initiates a request to establish a secure communication session with the relying party 120 using Transport Layer Security (TLS) protocol and the signal flow diagram illustrates the stages of the handshake process that occurs between the client device 108 and the relying party 120 to establish a TLS connection for a TLS session between the client device 108 and the relying party 120. While the example embodiment illustrated in FIG. 9 utilizes the TLS protocol, the techniques disclosed herein can be used to establish secure communication sessions using other secure communication protocols.

The handshake process 900 can be used to exchange various parameters that will be used to establish the TLS session between the client device 108 and the relying party 120. The handshake process starts with a negotiation phase that includes stages 910, 920, and 930. The client device 108 and the relying party 120 can be configured to undertake a negotiation process in which the client device 108 and the relying party 120 exchange information regarding the encryption capabilities of the client device 108 and the relying party 120. During this negotiation process, the client device 108 and the relying party 120 can exchange information that can be used to generate the encryption keys that can be used by the client device 108 and the relying party 120 to encrypt data to be exchanged during the TLS session. The client device 108 and the relying party 120 can also be configured to determine a cipher suite to be used to encrypt the communications between the client device 108 and the relying party 120 during the TLS session.

The client device 108 can send a “ClientHelloMessage” (stage 910) to the relying party 120. The ClientHelloMessage can include various parameters that can be used by the relying party 120 to establish the TLS session with the client device 108. The ClientHelloMessage parameters can include an indicator identifying a highest TLS token binding protocol version supported by the client device 108. The parameters can also include a list of cryptographic algorithms that are supported by the client device 108. The parameters can also include a list of list of compression methods that are supported by the client device 108. The cryptographic algorithms and the compression methods can be listed in order of preference of the client device 108.

In one embodiment, the parameters can may be represented using a TokenBindingKeyParameters structure, and example of which follows this paragraph. The structure can include a token_binding_version field in which the version of the token binding protocol being used can be specified. Other parameters associated with the token binding protocol may be specified in the key_parameters list_field. The attestation_length_bytes field can be used to indicate a length of the attestation information included in the attestation_data field.

```
struct {
      ProtocolVersion token_binding_version;
      AttestationType token_binding_attestation_type;
      TokenBindingKeyParameters key_parameters_list<1..2\hat{ }8−1>;
      attestation_length_bytes<1..2\hat{ }8−1>;
      attestation_data<1..2\hat{ }(8*attestation_length_bytes)>
} TokenBindingParameters;
```

The ClientHelloMessage can also include an access token and attestation information as parameters. Information included in the access token can be used to securely bind one or more TLS connections to the TLS session to prevent a malicious third party from obtaining the access token and presenting the access token to web services, such as those provided by the relying party 120, in order to impersonate an authorized user of those services. The ClientHelloMessage can also include a session identifier (also referred to herein as a session ID or TLS session ID) that can be used if the client is attempting to resume an existing TLS session. If the session ID is valid and represents an existing session, the client device 108 and the relying party 120 can avoid having to engage in the steps discussed below for establishing session keys and the client device 108 and the relying party 120 can resume the session utilizing the existing session keys.

The relying party 120 can respond to the ClientHelloMessage with a ServerHelloMessage (stage 920). The ServerHelloMessage can include the chosen cipher suite, compression method, and version of TLS to be used for the TLS session. The selected version of TLS can support a version of the TLS token binding that is equal to or less than the version of the TLS binding protocol that the client device 108 indicated that the client device 108 could support in the ClientHelloMessage. The ServerHelloMessage can also include a nonce value, which can be a randomly generated number value, that can later be used to generate a master key that can be used to encrypt communications that are part of the TLS session.

The nonce value can also be used to determine whether the client device 108 is possession of the private key associated with the access token. The relying party 120 can also be configured to use the public key included in the access token provided in the ClientHelloMessage to encrypt the nonce value included in the ClientHelloMessage using a public key associated with the client device 108. The relying party 120 can be configured to send the encrypted nonce value to the client device 108 in the ServerHelloMessage or in another message send by the relying party 120 to the client device 108. The client device 108, upon receiving the encrypted nonce value, can decrypt the encrypted nonce value using the appropriate private key maintained by the client device 108. The client device 108 can then return the encrypted nonce value to the relying party 120. The client device 108 may reencrypt the nonce value with a public key of the relying party 120 before sending the nonce value back to the relying party 120. If the client device 108 does not provide the correct unencrypted nonce value (or encrypted with the public key of the relying party 120) to the relying party 120, the relying party 120 can be configured to terminate the secure communication session with the client device 108. The client device 108 can be configured to send the nonce value back to the relying party 120 in a message following the ServerHelloMessage at stage 920. In some implementations, the client device 108 can be configured to send the nonce value back to the server with the message sent in one of stages 926, 930, or 940 or in another message not illustrated in the signal flow diagram. The process of encryption of the nonce value by the relying party 120, the decryption by the client device 108, and the sending of the decrypted nonce value back to the relying party 120 can be used by the relying party 120 to establish that the client device 108 possesses the private key associated with the binding of the access token to the secure communication session.

In other embodiments, the relying party 120 can be configured to extract information from the access token that has been encrypted using the public associated with the client device 108. The access token may not include the public key itself in such implementations, and the relying party 120 can be configured to obtain the public key from the client device 108 by sending the ClientCertificateRequest message discussed below to the client device 108, and the client device 108 can respond with a ClientCertificate message that includes the public key of the client device 108. The relying party 120 can send a message to the client device 108 requesting that the client device 108 decrypt the information from the access token that has been encrypted using the public associated with the client device 108. The client device 108 decrypt the encrypted information using the private key of the client device 108 and can include the decrypted value in response message to the relying party 120. The client device 108 can be configured to encrypt the response message contents using a public key of the relying party 120 to ensure that the information extracted from the token is not transmitted in an unencrypted form across the network 112. The relying party 120 can be configured compare the response from the client device 108 with a reference value associated with the client device to determine whether the client device 108 is in possession of the private key of the private key-public key pair used to generate the access token. The reference value may be obtained from the access server 110 or may be maintained in a database of the relying party 120 where the relying party 120 implements the functionality of the access server 110.

Once the possession of the private key and the access token by the client device 108 have been established, the relying party can be configured to examine the attestation information. The relying party can be configured to access policy information and use the policy information and the attestation information to determine whether the establish the TLS connection with the client device 108. The policy information can include specific requirements that are imposed on specific applications, content, and/or services provided by the relying party 120. The relying party 120 can also compare the attestation information provided by the client device 108 with policy information to determine whether to establish the secure communication session with the client device. The relying party 120 can use the attestation information to determine the configuration of the client device 108 and can use the attestation information to determine how the client device 108 is managing the private keys and the access tokens used by the relying party 120. As discussed above, the relying party 120 can use policy information to determine whether the client device 108 is managing the access tokens and/or the private keys in a sufficiently secure manner, and the relying party 120 can refuse to terminate the secure communication session and/or a connection associated with the secure communication session responsive to the client device 108 not satisfying the security requirements associated with management of the access token and/or the encryption keys imposed by the policy.

The relying party 120 can send a ServerCertificate message to the client device 108 (stage 922). The ServerCertificate message can include the server's public key. The client device 108 can be configured to use the public key to authenticate the relying party 120 and to encrypt the PreMasterSecret (discussed below).

The relying party 120 can also send a ClientCertificateRequest message to the client device 108 (stage 924) requesting that the client device 108 provide the client device's public key. Stage 924 can be optional. The client device 108 can provide the public key with the attestation information and the access token provided with the ClientHelloMessage in stage 910. The relying party 120 can use the public key of the client device 108 to authenticate the client device 108. In some embodiments, the public key of the client device 108 can be included in the access token, and the relying party 120 can be configured to compare the public key provided by the client device 108 with public key information extracted from the access token to determine whether there is a mismatch between the public key provided by the client device 108 and the public key information extracted from the access token.

The client device 108 can respond to the ServerHelloMessage with a ClientKeyExchange message (stage 930). The client device 108 can be configured to generate a second nonce value, which can be a randomly generated number value. The client device 108 can then encrypt the second nonce value with the public key of the certificate of the relying party 120. The client device 108 can obtain the certificate from the relying party 120 via the ServerHelloMessage or via another message from the relying party 120. The client device 108 can use the cipher suite indicated in the ServerHelloMessage to encrypt the second nonce value using the public key of the relying party 120. The encrypted second nonce value can be sent to the server with the ClientKeyExchange message. The encrypted data can also be referred to as a “PreMasterSecret” value. The client device 108 and the relying party 120 can be configured to use the PreMasterSecret to compute a MasterSecret value. The MasterSecret value can be used to generate other key data. The client device 108 and the relying party 120 can be configured to pass the MasterSecret value through Pseudo-Random Number Generators (PRNGs) to generate key data to be used during the TLS session.

The client device 108 can follow the ClientKeyExchange message with a ChangeCipherSpec message (stage 940). The ChangeCipherSpec can be used to signal to the relying party 120 that subsequent communications from client device 108 that are part of the TLS session will be encrypted using the session keys. The client device 108 can follow the ChangeCipherSpec message with a Finished message (stage 950). The Finished message can comprise contents encrypted using the key data generated during the negotiation phase with the relying party 120.

The relying party 120 can generate a ChangeCipherSpec message to the client device 108 responsive to receiving the Finished message from the client device 108 (stage 960). The relying party 120 can be configured to decrypt the Finished message from the client device 108 using the exchanged secret information. If the relying party 120 cannot successfully decrypt the contents of the finished message, the TLS connection session can be halted and the connection between the client device 108 and the relying party 120 can be torn down. Otherwise, if the relying party 120 successfully decrypts the contents of the Finished message from the client device 108, the relying party 120 can send the ChangeCipherSpec message to the client device 108. The relying party 120 can follow the ChangeCipherSpec message with a Finished message (stage 970). The contents of the Finished message are encrypted by the relying party 120 using the selected cipher suite. The client device 108 can decrypt the Finished message upon receipt, and if the client device 108 cannot decrypt the contents of the Finished message from the relying party 120, the TLS connection session can be halted and the connection between the client device 108 and the relying party 120 can be torn down. Otherwise, if the client device 108 can successfully decrypt the contents of the Finished message from the server, the TLS handshake is completed, and the client device 108 and the relying party 120 can communicate data over the TLS connection that has been encrypted using the keys generated during the handshake process and using the cipher suite selected during the handshake process.

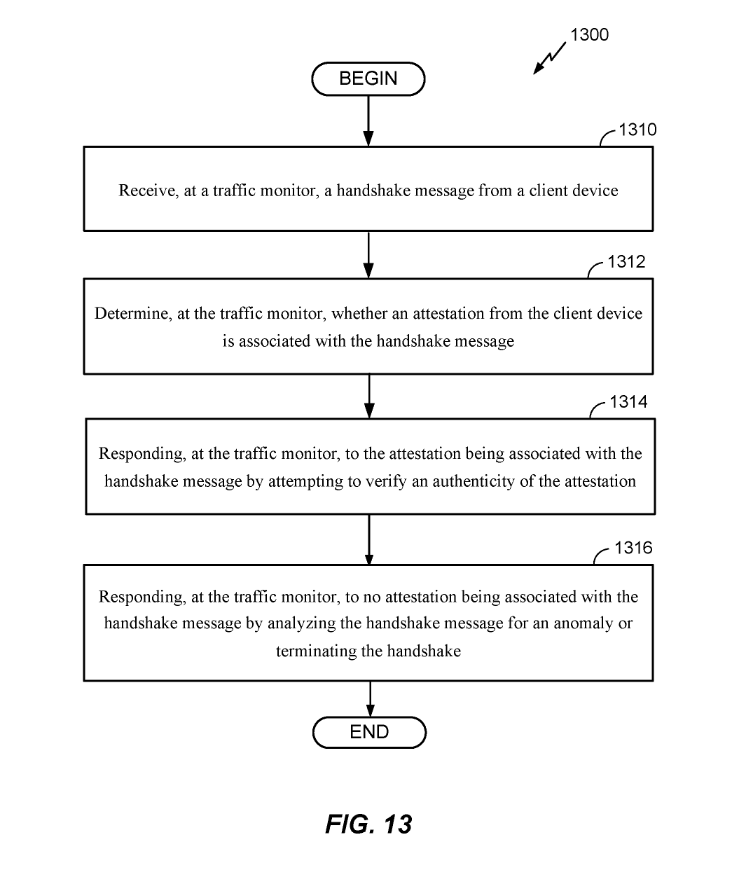

The example processes illustrated in FIGS. 11-13 can be used to detect traffic anomalies. The traffic anomaly processes illustrated herein can be used in conjunction with the token binding processes illustrated in FIGS. 5, 6, 7A, 7B, 8A, and 8B or can be used as separate attestation processes for detecting traffic anomalies. The example processes illustrated in FIGS. 11-13 can be used to provide information regarding the health and configuration of the client device 108, while the example processes illustrated in FIGS. 5, 6, 7A, 7B, 8A, and 8B relate to attestation of how the client device 108 protects access tokens, private keys, and/or other such sensitive information.

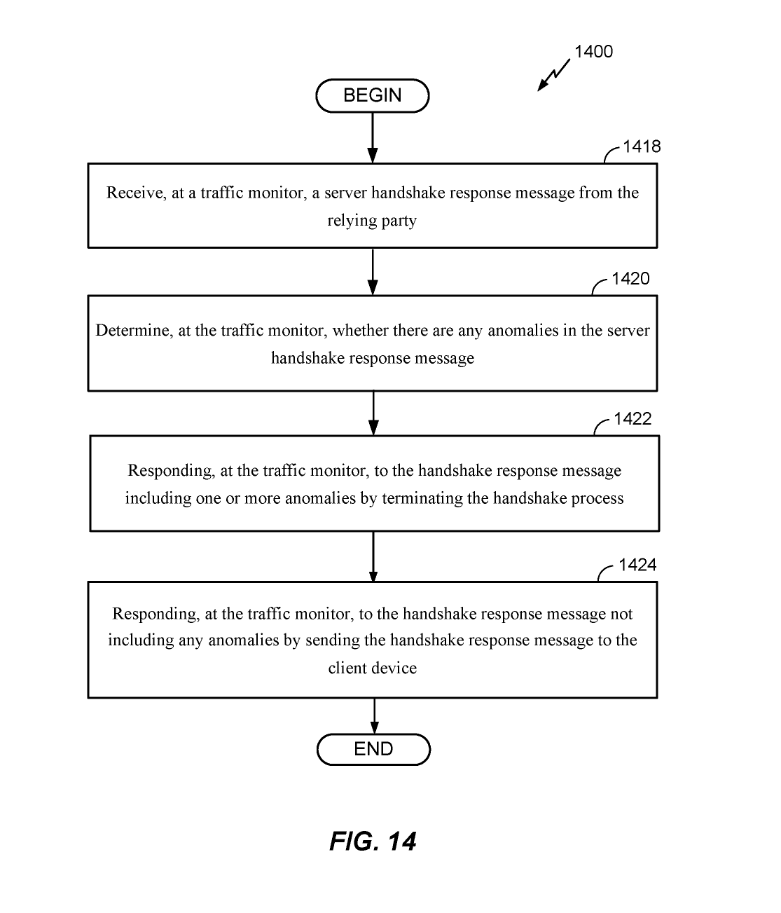

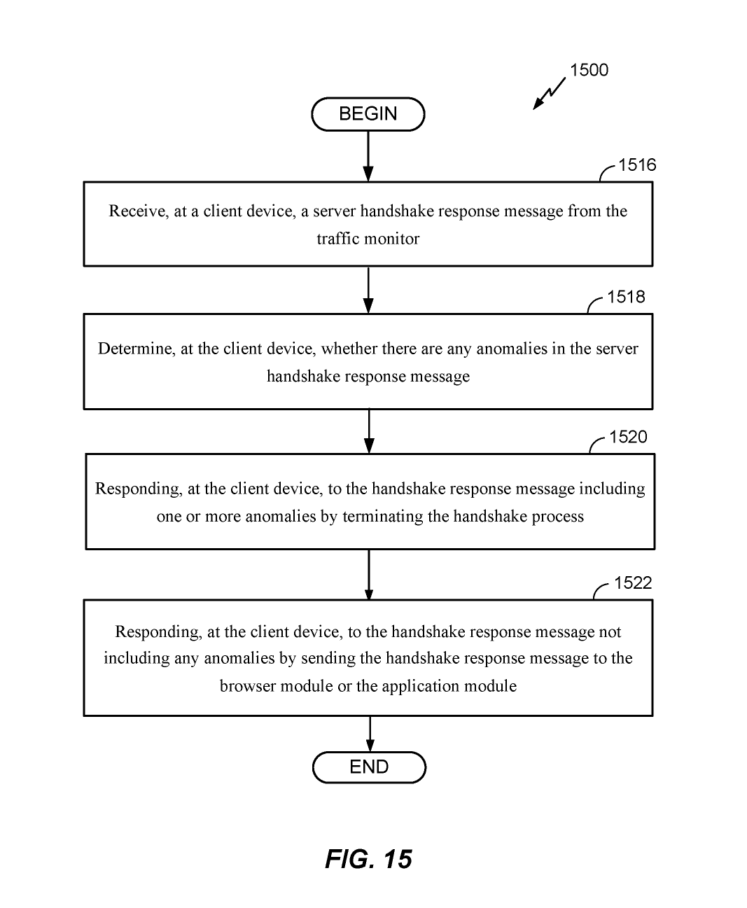

FIG. 11 is a flow diagram of an example process 1100 of traffic anomaly detection. The process 1100 of FIG. 11 can be implemented in the secure communications module 226 of the client device 108. FIG. 13 is a flow diagram of an example process 1300 of traffic anomaly detection that can be implemented in the traffic monitor 107 and can be implemented by the anomaly detection module of the traffic monitor 107. FIGS. 11 and 13 are discussed in conjunction with the example handshake process 1200 illustrated in FIG. 12, which illustrates an example implementation of the processes illustrated in FIGS. 11 and 13. FIG. 12 is a swim-lane diagram illustrating a handshake process 1200 between the browser module 222 of the client device 108 and the relying party 120 in which the traffic monitor 107 is disposed as an intermediary device between the client device 108 and the relying party 120.

With reference to the example process 1100 of FIG. 11, with further reference to FIGS. 1-2 and 10, a web browser implemented by the browser module 222 of the client device 108 communicates with the relying party 120 via the traffic monitor 107 (in contrast with the example processes illustrated in FIGS. 7A, 7B, 8A, 8B, and 9 in which the client device 108 does not communicate with the relying party 120 via the traffic monitor 107).

The anomaly detection module 1016 of the traffic monitor 107 is configured to analyze and verify the attestation information that accompanies a TLS handshake and to analyze the attestation information that accompanies an access token. The traffic monitor 107 can be configured to identify non-verified traffic and to perform anomaly detection processing on the non-verified traffic. The processing performed by the anomaly detection module 1016 of the traffic monitor 107 can be similar to that performed by the secure communications module 226 of the client device 108. The anomaly detection module 1016 of the traffic monitor 107 can be further configured to classify traffic from the client device 108 that has been routed through the traffic monitor 107 based on the attestation information that accompanies a TLS handshake that is performed between the client device 108 and the relying party 120 via the traffic monitor 107.

The process 1100 includes producing, at a client device, a handshake message for initiating a handshake with a relying party (stage 1110). For example, the browser module 222 implemented by the client device 108 can be activated to retrieve content from the relying party 120 using a secure connection, e.g., using a TLS session. The browser module 222 can produce and send a handshake message, such as a ClientHelloMessage similar to that of stage 910 of the process illustrated in FIG. 9, to the client device 108 to initiate the secure connection (stage 1210). The ClientHelloMessage includes a cipher suite, i.e., an indication of one or more available cipher techniques and/or a requested cipher technique that are supported by the browser module 222 and the client device 108. The ClientHelloMessage can also indicate a highest TLS token binding protocol version supported by the client device 108.

The process 1100 further includes analyzing, at the client device 108, the handshake message to determine whether the handshake message is anomalous (stage 1112). The handshake message can be analyzed by the secure communications module 226 of the client device 108. The secure communications module 226 can be configured to determine whether the handshake message is anomalous by checking the 5-tuple of source IP address, source port, destination IP address, destination port, and traffic type associated with the connection. The information comprising the 5-tuple are values that are required to establish a secure, bidirectional network connection between the client device 108 and the relying party 120. The secure communications module 226 can compare observed 5-tuple values with expected 5-tuple values for a connection between the client device 108 and the relying party 120. Any deviation between the expected values and the observed values can result in the secure communications module 226 making a determination that the handshake is anomalous. The secure communications module 226 can also be configured to verify the cipher suite specified in the handshake message. The secure communications module 226 can be configured to make a determination that the handshake is anomalous responsive to the cipher suite containing unexpected content, such as a null cipher suite. The secure communications module 226 of the client device 108 can also be configured to analyze a certificate in the handshake message. The secure communications module 226 can be configured to determine whether the certificate provided in the handshake message is valid and/or whether the certificate is associated with the client device 108. The secure communications module 226 can be configured to make a determination that the handshake is anomalous responsive to the certificate being invalid, not being associated with the client device 108, and/or other issues related to the certificate in the handshake message.

The secure communications module 226 can be configured to analyze application characteristics indicated by the handshake message. The application characteristics can be one or more expected characteristics of the information provided in the handshake message that based on an application that is the source of the request. For example, the browser module 222 may implement a web browser that is expected to request a particular cipher suite and deviating from that may indicate that the handshake message is anomalous. The handshake message can also be generated by an application, such as a social media application, a financial application, a streaming media application, or other type of application that is operating on the client device 108 and may request content from the relying party 120. The secure communications module 226 can monitor the handshake message to determine whether the application has requested to connect with a different destination that is expected, has requested a different type of traffic that is normally expected (e.g. financial application requesting streaming content). The secure communications module 226 can be configured to make a determination that the handshake is anomalous responsive to the application characteristics deviating from an expected values. The secure communications module 226 can terminate the handshake responsive to determining that the handshake message is anomalous according to any of the examples listed above or responsive to determining that the handshake message is anomalous in view of other criteria instead of or in addition to one or more of the criteria discussed in the above examples.

The process 1100 further includes associating, at the client device, an attestation with the handshake message, the attestation indicating whether the client device determined that the handshake message is anomalous (1114). The secure communications module 226 of the client device 108 can be configured to associate attestation information with the handshake message indicating whether the secure communications module 226 determined that the handshake message was anomalous. The secure communications module 226 can be configured to enrich the handshake message with information indicative of whether the handshake message is anomalous. For example, the secure communications module 226 can be configured to add the attestation information to the ClientHelloMessage received from the browser module 222 (or application implemented by the application module 218). The secure communications module 226 can be configured to add the attestation information to an attestation data structure that can be included in the ClientHelloMessage. The secure communications module 226 can be configured to add the attestation information to the same attestation data structure as that discussed above with respect to stage 910 of FIG. 9 or to a separate data structure. For example, the secure communications module 226 can be configured to store the attestation data related to the protection of the access token, private keys, and/or other sensitive information by the client device 108 in a separate data structure than the attestation data related to the attestation of the health or behavior of the client device 108. The secure communications module 226 can be configured to cache data related to attestation in a memory of the client device 108. The attestation information provided to the traffic monitor 107 may include an indication that something is wrong in the ClientHelloMessage. The secure communications module 226 can be configured to store detailed information regarding what caused the secure communications module 226 to determine that the ClientHelloMessage was anomalous. This detailed information may later be sent to the traffic monitor 107 or accessed from the client device 108 to provide detailed information as to what caused the handshake process to fail. This information may be used to provide information about the health of the client device 108, the browser module 222, the application module 218, or a combination thereof, and that may be used to diagnose problems with one or more of these components.

The process 1100 can be followed by the client device 108 sending the handshake message and the attestation information to the traffic monitor 107.

FIG. 15 is a flow diagram of an example process 1500 of traffic anomaly detection. The process 1500 of FIG. 15 can be implemented in the secure communications module 226 of the client device 108. The process 1500 can be used to implement additional stages to the process 1100 illustrated in FIG. 11 to process a server response message received in response to the handshake message send by the client device 108 following stage 1114 of the process 1100. The process 1500 can also be used to implement, at least in part, stages 1226 and 1228 of the handshake process 1200 illustrated in FIG. 12.

A server handshake response can be received at the client device 108 (stage 1516). The traffic monitor 107 can be configured to forward the ServerHelloMessage received from the relying party 120 to the client device 108. The ServerHelloMessage can be similar to that discussed with respect to stage 920 of the process illustrated in FIG. 9.

The server response can be analyzed for anomalies (stage 1518). The secure communications module 226 of the client device 108 can be configured to analyze the ServerHelloMessage for anomalies. The traffic monitor 107 may have already analyzed the ServerHelloMessage for anomalies and forwarded the ServerHelloMessage to the client device 108 after detecting no anomalies. The secure communications module 226 can be configured to verify the cipher suite specified in the ServerHelloMessage message. The secure communications module 226 can be configured to make a determination that the handshake is anomalous responsive to the cipher suite containing unexpected content, such as a null cipher suite, or a different cipher suite than was specified in the ClientHelloMessage. The secure communications module 226 of the client device 108 can also be configured to perform other checks on the contents of the ServerHelloMessage to identify any unexpected parameters values that are indicative of the ServerHelloMessage being anomalous.

The handshake process can be terminated responsive to anomalies being detected (stage 1520). The secure communications module 226 can be configured to terminate the handshake process between the client device 108 and the relying party 120 responsive to one or more anomalies being detected in the ServerHelloMessage. The secure communications module 226 can be configured to store at least a portion of the ServerHelloMessage and/or reasons for determining that the ServerHelloMessage was anomalous. The secure communications module 226 can also be configured to perform one or more other actions responsive to determining that the ServerHelloMessage is anomalous. For example, the secure communications module 226 can be configured to notify the browser module 222 or the application module 218 from which the ClientHelloMessage originated to establish the secure communication session between the client device 108 and the relying party 120. The secure communications module 226 and/or the browser module 222 or the application module 218 can be configured to display a message on a display of the client device 108 and/or otherwise notify a user of the client device 108 that a secure communication session between the client device 108 and the relying party 120 could not be established. The notification may include information identifying the one or more anomalies that were identified in the ServerHelloMessage.

The server response can be forwarded to the browser module 222 or the application module 218 responsive to no anomalies being detected (stage 1522). The ServerHelloMessage can be forwarded to the browser module 222 or the application module 218 originated to establish the secure communication session between the client device 108 and the relying party 120. The handshake process between the client device 108 and the relying party 120 may continue with additional stages, such as stages 922, 924, 926, and 930 of the negotiation phase of the between the client device 108 and the relying party 120 illustrated in FIG. 9.

FIG. 13 is a flow diagram of an example process 1300 of traffic anomaly detection that can be implemented in the traffic monitor 107 and can be implemented by the traffic monitor 107. The process illustrated in FIG. 13 can be used be implemented by the anomaly detection module 1016 of the traffic monitor 107.

A handshake message from the client device 108 can be received at the traffic monitor (stage 1310). The anomaly detection module 1016 of the traffic monitor 107 can be configured to receive a ClientHelloMessage from the client device 108 via the one or more network interfaces 1004 of the traffic monitor 107. The ClientHelloMessage can be the handshake message generated in stage 1110 of the process 1100 illustrated in FIG. 11 or the handshake message generated by the browser module 222 in stage 1210 of the process illustrated in FIG. 12. The ClientHelloMessage can be similar to that discussed with respect to stage 910 of the process illustrated in FIG. 9.

A determination can be made at the traffic monitor whether an attestation from the client device 108 is associated with the handshake message (stage 1312). The client device 108 can be configured to analyze the handshake message, as discussed above with respect to stage 1112 of the process 1100 of FIG. 11, and to provide attestation information with the ClientHelloMessage. The attestation information can be included in the ClientHelloMessage itself or may be included in a separate communication protocol message. The attestation information also be included in a message generated by the network stack of the client device 108. The client device 108 may not provide attestation information in some instances. The attestation information can include information that identifies anomalies in the handshake message that were identified by the client device 108 but did not cause the client device 108 to abort the handshake process between the client device 108 and the relying party 120. The anomaly detection module 1016 of the traffic monitor 107 can be configured to analyze the anomaly information provided by the client device 108 to determine whether to abort the handshake between the client device 108 and the relying party 120.

The traffic monitor 107 can be configured to respond to the attestation being associated with the handshake message by attempting to verify the authenticity of the attestation (stage 1314). The anomaly detection module 1016 of the traffic monitor 107 can be configured to determine whether attestation information was provided by the client device 108. If the client device 108 provided attestation information, the anomaly detection module 1016 of the traffic monitor 107 can be configured to verify whether the attestation is authentic. The attestation information provided with the handshake can comprise an access token as discussed in preceding examples which can be used to authenticate the attestation. The attestation information or a portion thereof can be signed using a private key associated with the client device 108 or a private key associated with an access token associated with the client device 108. The traffic monitor 107 can be configured to verify the signature to verify the authenticity of the attestation.

The traffic monitor 107 can be configured to respond to no attestation being associated with the handshake message by the analyzing the handshake message for an anomaly or by terminating the handshake (stage 1316). The anomaly detection module 1016 of the traffic monitor 107 can be configured to analyze the attestation information provided with the ClientHelloMessage to determine whether there are any anomalies in the ClientHelloMessage. The anomaly detection module 1016 of the traffic monitor 107 can be configured to perform an analysis on the ClientHelloMessage similar to that performed by the secure communications module 226 of the client device 108 in stage 1112 of process 1100 illustrated in FIG. 11. The anomaly detection module 1016 of the traffic monitor 107 may not have some information that is available to the client device 108, and thus, may not be able to verify some anomalies in the ClientHelloMessage that the secure communications module 226 may have been able to identify. For example, where the client device 108 is assigned a dynamic IP address by a local network to which the client device 108 is attached, the source IP address can change over time making more difficult for the anomaly detection module 1016 of the traffic monitor 107 to determine whether a ClientHelloMessage includes a valid source IP address or not. Because the client device 108 know whether the ClientHelloMessage originated from the browser module 222 or the application module 218 of the client device 108, the secure communications module 226 can verify the 5-tuple by checking just the destination IP address, destination port, and the traffic type. However, if the 5-tuple is checked at the traffic monitor 107, all five of the parameters of the 5-tuple are potentially suspect and need to be checked if no attestation is provided with the ClientHelloMessage. The anomaly detection module 1016 of the traffic monitor 107 can be configured to halt the handshake process if anomalies are detected in the ClientHelloMessage. In some implementations, the anomaly detection module 1016 of the traffic monitor 107 can be configured to halt the handshake process responsive to no attestation information being provided.

FIG. 14 is a flow diagram of an example process 1400 of traffic anomaly detection. The process 1400 of FIG. 14 can be implemented in the anomaly detection module 1016 of the traffic monitor 107. The process 1500 can be used to implement additional stages to the process 1300 illustrated in FIG. 13 to process a server response message received in response to the handshake message send by the client device 108. The process 1400 can also be used to implement, at least in part, stages 1222 and 1224 of the handshake process 1200 illustrated in FIG. 12.

A server handshake response can be received (stage 1418). The anomaly detection module 1016 of the traffic monitor 107 can receive, via the one or more network interfaces 1004 of the traffic monitor 107, the ServerHelloMessage provided by the relying party 120 in response to the ClientHelloMessage. The ServerHelloMessage can be similar to that discussed with respect to stage 920 of the process illustrated in FIG. 9.

The server handshake response can be analyzed for anomalies (stage 1420). The anomaly detection module 1016 of the traffic monitor 107 can be configured to analyze the ServerHelloMessage received from the relying party 120. The anomaly detection module 1016 of the traffic monitor 107 can be configured to analyze the session parameters and other information included in the ServerHelloMessage sent by the relying party 120 to determine whether any anomalies are present in the response from the relying party 120. For example, the ServerHelloMessage may be indicative of a downgrade attack in which the ServerHelloMessage is used to specify an older or much less secure version of a communication protocol that uses a weaker cipher suite than the version of the communication protocol requested by the client device 108. A null cipher suite may have also been specified in the ServerHelloMessage in which no cryptographic protection would have been applied to the communications between the client device 108 and the relying party 120. The anomaly detection module 1016 of the traffic monitor 107 can be configured to terminate the handshake process 1200 responsive to detecting a downgrade attack or other anomaly. The anomaly detection module 1016 of the traffic monitor 107 can be configured to take other corrective actions responsive to detecting a downgrade attack or other anomaly.

The handshake process can be terminated responsive to anomalies being detected (stage 1422). The anomaly detection module 1016 of the traffic monitor 107 can be configured to terminate the handshake process between the client device 108 and the relying party 120 to set up a secure communication session responsive to the ServerHelloMessage including one or more anomalies. The anomaly detection module 1016 of the traffic monitor 107 can also be configured to notify the client device 108 that anomalies have been detected in the ServerHelloMessage and that the handshake process has been terminated. The notification can provide at least a portion of the ServerHelloMessage to the client device 108 and information about the one or more anomalies identified in the ServerHelloMessage.

The server response can be forwarded to the traffic monitor responsive to no anomalies being detected (stage 1424). The ServerHelloMessage received from the relying party 120 can be forwarded to the client device 108 responsive to the anomaly detection module 1016 not detecting any anomalies in the ServerHelloMessage.

FIG. 12 is a swim-lane diagram illustrating a handshake process 1200 between the browser module 222 of the client device 108 and the relying party 120 in which the traffic monitor 107 is disposed as an intermediary device between the client device 108 and the relying party 120. FIG. 12 illustrates the interactions between the browser module 222, the client device 108, the traffic monitor 107, and the relying party 120.

The browser module 222 of the client device 108 sends the ClientHelloMessage message to the client device 108 to initiate the process of establishing the secure connection with the relying party 120 (stage 1210). The browser module 222 of the client device 108 can generate the ClientHelloMessage as discussed above with respect to stage 1110 of the process 1100 of FIG. 11.

The client device 108 can analyze the ClientHelloMessage for any anomalies (stage 1212). The secure communications module 226 of the client device 108 can be configured to analyze the ClientHelloMessage as discussed above with respect to stage 1112 of the process 1100 of FIG. 11 and to determine whether there are any anomalies associated with this handshake message using the various techniques discussed above with respect to stage 1112.

The secure communications module 226 of the client device 108 can be configured to enrich the handshake message with attestation information and to send the handshake message to the traffic monitor 107 responsive to the secure communications module 226 of the client device 108 determining that there do not appear to be anomalies in the handshake message (stage 1214). The secure communications module 226 of the client device 108 can be configured to send the ClientHelloMessage to the traffic monitor 107 wirelessly via a wireless network interface of the client device 108, such as the one or more local area network transceivers 206 or the one or more wide area network transceivers 204, or via a wired network interface. As discussed above, the secure communications module 226 may be implemented, at least in part, in the software and/or hardware components of the wireless or wired network interface(s) of the client device 108, and the secure communications module 226 can be configured to affix the attestation information to the ClientHelloMessage before sending the ClientHelloMessage to the traffic monitor 107. Alternatively, the secure communications module 226 can be configured to terminate the handshake and end the handshake process 1200 responsive to determining that one or more anomalies exist within the ClientHelloMessage.

The traffic monitor 107 can receive the handshake message from the client device 108 and can analyze the handshake message and the attestation (stage 1216). The anomaly detection module 1016 of the traffic monitor 107 can be configured to analyze the ClientHelloMessage and the attestation information sent by the client device 108 as discussed in stages 1314 of the process illustrated in FIG. 13. The anomaly detection module 1016 of the traffic monitor 107 can be configured to determine whether attestation information was provided by the client device 108. If the client device 108 provided attestation information, the anomaly detection module 1016 of the traffic monitor 107 can be configured to verify whether the attestation is authentic as discussed with regard to stage 1314 of the process 1300 illustrated in FIG. 13. The anomaly detection module 1016 of the traffic monitor 107 can also be configured to determine whether the ClientHelloMessage is anomalous as also discussed with regard to stage 1314 of the process 1300 illustrated in FIG. 13. In some implementations, the client device 108 may not provide attestation information to the traffic monitor 107 with the handshake message, and the anomaly detection module 1016 of the traffic monitor 107 can also be configured to make a determination whether the handshake message is anomalous without analyzing any attestation information as also discussed with regard to stage 1316 of the process 1300 illustrated in FIG. 13. The anomaly detection module 1016 can be configured to terminate the handshake process 1200 responsive to the handshake message being anomalous and/or the anomaly detection module 1016 being unable to verify that the attestation information provided (where such information is provided) is authentic.

The traffic monitor 107 can send the handshake message to the relying party 120 (stage 1218) responsive to the anomaly detection module 1016 determining that the attestation was authentic (if provided) and the handshake message was not anomalous. The anomaly detection module 1016 of the traffic monitor 107 can be configured to send the ClientHelloMessage received from the client device 108 to the relying party 120 via a wired or wireless network connection using the one or more network interfaces 1004 of the traffic monitor 107. The ClientHelloMessage may pass through one or more intervening networks and/or network devices (now shown) to reach the relying party 120.

The relying party 120 can respond to the handshake message from the client device 108 with a handshake message of its own (stage 1220). The relying party 120 can respond with a ServerHelloMessage similar to that discussed above with respect to stage 920 of the process illustrated in FIG. 9. The ServerHelloMessage can include the chosen cipher suite, compression method, and version of TLS to be used for the TLS session between the client device 108 and the relying party 120. The ServerHelloMessage can also include other TLS session parameters, as discussed above with respect to stage 920 of the process illustrated in FIG. 9.

The traffic monitor 107 can be configured to receive the handshake message from the relying party 120 and to analyze the handshake message (stage 1222). The anomaly detection module 1016 of the traffic monitor 107 can be configured to analyze the session parameters and other information included in the ServerHelloMessage sent by the relying party 120 to determine whether any anomalies are present in the response from the relying party 120. For example, the ServerHelloMessage may be indicative of a downgrade attack in which the ServerHelloMessage is used to specify an older or much less secure version of a communication protocol that uses a weaker cipher suite than the version of the communication protocol requested by the client device 108. A null cipher suite may have also been specified in the ServerHelloMessage in which no cryptographic protection would have been applied to the communications between the client device 108 and the relying party 120. The anomaly detection module 1016 of the traffic monitor 107 can be configured to terminate the handshake process 1200 responsive to detecting a downgrade attack or other anomaly. The anomaly detection module 1016 of the traffic monitor 107 can be configured to take other corrective actions responsive to detecting a downgrade attack or other anomaly.

The traffic monitor 107 can forward the handshake message from the relying party 120 (stage 1224). The anomaly detection module 1016 of the traffic monitor 107 can be configured to send the ServerHelloMessage received from the relying party 120 to the client device 108 via a wired or wireless network connection using the one or more network interfaces 1004 of the traffic monitor 107.

The client device 108 can be configured to analyze the handshake message from the relying party 120 (stage 1226). The secure communications module 226 of the client device 108 can be configured to analyze the ServerHelloMessage to verify the cipher suite selected by the relying party 120 to determine whether the cipher suite specified in the ServerHelloMessage is compatible with that specified in the ClientHelloMessage and/or other a null cipher suite was specified in the ServerHelloMessage. The secure communications module 226 of the client device 108 can be configured to provide the ServerHelloMessage to complete the handshake process (or at least the initial exchange of messages of such an exchange) to the browser module 222 responsive to determining that there are not any anomalies in the ServerHelloMessage. The secure communications module 226 can be configured to examine additional messages exchanged between the client device 108 and the relying party 120, such as those of the negotiation phase discussed with respect to the handshake process 900 of FIG. 9. The secure communications module 226 can be configured to halt the handshake process 1200 responsive to determining that the ServerHelloMessage or a subsequent message exchanged between the client device 108 and the relying party 120 is anomalous.

Example implementations according to the disclosure include:

E1. An example traffic anomaly detection method comprising:

receiving, at a traffic monitor, a handshake message from a client device;

determining, at the traffic monitor, whether an attestation from the client device is associated with the handshake message; and

either:
responding, at the traffic monitor, to the attestation being associated with the handshake message by attempting to verify an authenticity of the attestation; or
responding, at the traffic monitor, to no attestation being associated with the handshake message by analyzing the handshake message for an anomaly or terminating the handshake.
   E2. The method of example E1, wherein the method comprises the traffic monitor responding to the attestation being associated with the handshake message by attempting to verify an authenticity of the attestation, the method further comprising responding to failing to verify the authenticity of the attestation, or verifying that the attestation is authentic and indicates that the handshake message is anomalous, by analyzing the handshake message for an anomaly or terminating the handshake.
   E3. The method of example E2, wherein the processor is further configured to send the handshake message to a relying party responsive to verifying that the handshake message is not anomalous.
   E4. The method of example E1, wherein the method comprises the traffic monitor responding to the attestation being associated with the handshake message by attempting to verify an authenticity of the attestation, the method further comprising responding to verifying that the attestation is authentic and indicates that the handshake message is not anomalous by sending the handshake message to a relying party.
   E5. An example apparatus comprising:

means for receiving a handshake message from a client device;

means for determining whether an attestation from the client device is associated with the handshake message;

means for responding to the attestation being associated with the handshake message by attempting to verify an authenticity of the attestation; and

means for responding to no attestation being associated with the handshake message by analyzing the handshake message for an anomaly or terminating the handshake.

E6. The apparatus of example E5, wherein the means for responding to the attestation being associated with the handshake message further comprises:

means for attempting to verify an authenticity of the attestation responsive to the attestation being associated with the handshake message; and

means for analyzing the handshake message for an anomaly or terminate the handshake responsive to the failing to verify the authenticity of the attestation.

E7. The apparatus of example E6, wherein the processor is further configured to send the handshake message to a relying party responsive to verifying that the handshake message is not anomalous.
E8. The apparatus of example E5, wherein the means for responding to the attestation being associated with the handshake message further comprise:

means for verifying an authenticity of the attestation; and

means for sending the handshake to a relying party responsive to verifying that the attestation is authentic and indicates that the handshake message is not anomalous.

E9. An example non-transitory, computer-readable medium, having stored thereon computer-readable instructions for traffic anomaly detection, comprising instructions configured to cause a computing device to:

receive a handshake message from a client device;

determining whether an attestation from the client device is associated with the handshake message; and

either:
respond to the attestation being associated with the handshake message by attempting to verify an authenticity of the attestation; or
respond to no attestation being associated with the handshake message by analyzing the handshake message for an anomaly or terminating the handshake.
   E10. The non-transitory, computer-readable medium of example E9, further comprising instructions configured to cause the computing device to:

attempt to verify an authenticity of the attestation responsive to the attestation being associated with the handshake message; and

analyze the handshake message for an anomaly or terminate the handshake responsive to the failing to verify the authenticity of the attestation.

E11. The non-transitory, computer-readable medium of example E10, further comprising instructions configured to cause the computing device to:

send the handshake message to a relying party responsive to verifying that the handshake message is not anomalous.

E12. The non-transitory, computer-readable medium of example E9, further comprising instructions configured to cause the computing device to:

send the handshake message to a relying party responsive to verifying that the attestation is authentic and indicates that the handshake message is not anomalous.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device 410 or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A traffic anomaly detection method comprising:
producing, at a client device, a handshake message for initiating a handshake with a relying party;
analyzing, at the client device, the handshake message to determine whether the handshake message is anomalous; and
associating, at the client device, an attestation with the handshake message, the attestation indicating whether the client device determined that the handshake message is anomalous.

2. The method of claim 1, wherein analyzing the handshake message comprises analyzing a 5-tuple of source Internet Protocol address, source port, destination Internet Protocol address, destination port, and traffic type to determine whether the 5-tuple is within expectations.

3. The method of claim 1, wherein analyzing the handshake message comprises analyzing a cipher suite of the handshake message.

4. The method of claim 1, wherein analyzing the handshake message comprises analyzing a certificate of the handshake message.

5. The method of claim 1, wherein analyzing the handshake message comprises analyzing application characteristics.

6. The method of claim 1, wherein analyzing the handshake message comprises analyzing a combination of source application, destination address, and traffic type.

7. A device comprising:
a transceiver;
a memory; and
a processor communicatively coupled to the transceiver and to the memory, the processor configured to:
produce a handshake message for initiating a handshake with a relying party;
analyze the handshake message to determine whether the handshake message is anomalous; and
associate an attestation with the handshake message, the attestation indicating whether the processor determined that the handshake message is anomalous.

8. The device of claim 7, wherein to analyze the handshake message the processor is configured to analyze a 5-tuple of source Internet Protocol address, source port, destination Internet Protocol address, destination port, and traffic type to determine whether the 5-tuple is within expectations.

9. The device of claim 7, wherein to analyze the handshake message the processor is configured to analyze a cipher suite of the handshake message.

10. The device of claim 7, wherein to analyze the handshake message the processor is configured to analyze a certificate of the handshake message.

11. The device of claim 7, wherein to analyze the handshake message the processor is configured to analyze application characteristics.

12. The device of claim 7, wherein to analyze the handshake message the processor is configured to analyze a combination of source application, destination address, and traffic type.

13. The device of claim 7, wherein to produce the handshake message the processor is configured to implement a web browser and wherein the handshake message is a transport layer security message.

14. A traffic monitor comprising:
a transceiver;
a memory; and
a processor communicatively coupled to the transceiver and to the memory, the processor configured to:
receive a handshake message from a client device via the transceiver;
determine whether an attestation from the client device is associated with the handshake message;
respond to the attestation being associated with the handshake message by attempting to verify an authenticity of the attestation; and
respond to no attestation being associated with the handshake message by analyzing the handshake message for an anomaly or terminating a handshake.

15. The traffic monitor of claim 14, wherein the processor is configured to attempt to verify the authenticity of the attestation responsive to the attestation being associated with the handshake message, and wherein the processor is further configured to analyze the handshake message for an anomaly or to terminate the handshake responsive to failing to verify the authenticity of the attestation.

16. The traffic monitor of claim 14, wherein the processor is further configured to:
send the handshake message to a relying party responsive to verifying that the handshake message is not anomalous.

17. The traffic monitor of claim 14, wherein the processor is further configured to respond to verifying that the attestation is authentic and indicates that the handshake message is not anomalous by sending the handshake message to a relying party via the transceiver.
